(19) United States
(12) Patent Application Publication
(10) Pub. No.: US 2024/0386395 A1
(43) Pub. Date: Nov. 21, 2024

(54) Online Intermediary Transaction Systems and Methods

(71) Applicant: Cherisse Lewis, Huntsville, AL (US)

(72) Inventor: Cherisse Lewis, Huntsville, AL (US)

(21) Appl. No.: 18/218,169

(22) Filed: Jul. 5, 2023

Related U.S. Application Data
(60) Provisional application No. 63/467,225, filed on May 17, 2023.

(51) Int. Cl. G06Q 20/02; G06Q 20/12; G06Q 20/42

(52) U.S. Cl. CPC G06Q 20/02; G06Q 20/12; G06Q 20/42; G06Q 20/407

(57) ABSTRACT

A computer implemented intermediary transaction method and system wherein an intermediary communicates with and mediates negotiations between senders (buyers) and receivers (sellers) and completes sales transactions over a network. The sender sends payment and transaction conditions to the intermediary over the network for the purchase of goods and/or services from a receiver. The intermediary sends the transaction conditions to the receiver and the receiver confirms or updates the transaction conditions. The intermediary notifies the sender of the receiver's confirmation or update of the transaction conditions. The sender receives the goods and/or services if there were no updates to the transaction conditions by the receiver or if the sender confirmed the updates of the transaction conditions. The intermediary sends payment to the receiver. The sender is guaranteed receipt of delivery prior to the release of payment and the receiver is guaranteed payment for delivery of goods without disputes.

### CROSS REFERENCE TO RELATED APPLICATION

This application claims priority to and the benefit of U.S. Provisional Patent Application No. 63/467,225, filed May 17, 2023, which is incorporated by reference herein in its entirety for all purposes.

### FIELD OF THE DISCLOSURE

The method and system of this disclosure relates to online purchase and payment for goods and/or services and, more particularly, to online purchase and payment for goods and/or services through an intermediary wherein the buyer and seller are able to negotiate their own transaction conditions for purchase and delivery of products and/or services.

### BACKGROUND OF THE DISCLOSURE

Online purchase and payment of goods and services though the internet is well established. Buyers connect online with the website of a seller, select a product or service, and pay the seller through an electronic payment system provided by or accepted by the seller. These online transaction systems are biased towards the seller. It is known to use an online intermediary in online purchasing transactions. An online intermediary facilitates bringing together buyers and sellers, providing infrastructure, as well as helping sellers and buyers in completing a payment transaction process. These online purchasing methods using an online intermediary are also biased towards either the buyer or the seller. For example, see U.S. Pat. No. 8,275,704 for a buyer driven intermediary online purchasing system that is buyer driven. There is no mechanism provided in these intermediary online purchasing systems for the buyer and seller to negotiate terms of a purchase agreement at the time of purchase or to enable the intermediary to enforce a purchase agreement. It would be a significant improvement in fairness and convenience to a buyer and seller if these features could be implemented in an intermediary online purchasing system and method that would ensure that buyers receive goods and/or services before payment is made to the seller and that sellers receive payment without dispute.

### SUMMARY OF THE DISCLOSURE

The computer implemented intermediary transaction method disclosed allows a sender (purchaser of goods and/or services, sender of payment) to connect to a computer system of an intermediary, over a network, using the sender's computer system, wherein the intermediary communicates with and mediates negotiations between the sender and a receiver (provider of goods and/or services, receiver of payment) in transactions over the network. The sender makes payment to the intermediary over the network for the purchase of goods and/or services from the receiver.

The sender enters over the network into electronic entry forms provided by the intermediary's computer, transaction conditions between the sender and the receiver for the purchase of goods and/or services. The sender also enters a confirmation of the transaction conditions and submits, over the network, the confirmed transaction conditions to the intermediary along with payment for goods and/or services and payment for intermediary fees to the intermediary.

The intermediary notifies the receiver, over the network through the receiver's computer system, of the sender's payment for goods and/or services to the intermediary. The receiver receives from the intermediary, over the network, the transaction conditions confirmed by the sender and the receiver enters into the electronic entry forms provided by the intermediary's computer system the receiver's confirmation of the transaction conditions that were confirmed by the sender. Alternatively, the receiver may update (modify) the transaction conditions confirmed by the sender and the receiver may then enter into the electronic entry forms the receiver's updated transaction conditions and enter a confirmation of the receiver's updated transaction conditions. The receiver then submits the confirmed transaction conditions of the sender, or the confirmed updated transaction conditions of the receiver, over the network, to the intermediary.

The intermediary then notifies the sender, over the network, of the confirmation by the receiver of the transaction conditions confirmed by the sender, or of the confirmation by the receiver of the updates to the transaction conditions by the receiver. The sender then receives the goods and/or services from the receiver if there were no updates to the transaction conditions by the receiver or if the sender confirmed the updates of the transaction conditions confirmed by the receiver. The sender then notifies, over the network, the intermediary that the sender received the goods and/or services from the receiver and the intermediary then transfers, over the network, the sender's payment for the goods and services to the receiver.

The intermediary confirms and verifies the transaction conditions confirmed by the sender and confirms and verifies the receiver's confirmation of the transaction conditions confirmed by the sender or confirms and verifies the receiver's confirmation of the receiver's updated transaction conditions.

The intermediary holds the sender's payment for goods and services in escrow until transaction conditions are met by the sender and the receiver. The sender and receiver make payments, over the network, to the intermediary for services provided to the sender and receiver by the intermediary.

The intermediary requests, over the network, the receiver to enter proof of completion of performance of the transaction conditions and the receiver enters into the electronic entry forms confirmation of completion of the performance of transaction conditions one the proof of completion of the performance of transaction conditions is entered into the electronic entry forms by the receiver. The intermediary verifies the proof of completion of the performance of the transaction conditions entered by the receiver and notifies, over the network, the sender of the proof of completion of the performance of transaction conditions entered by the receiver. The sender enters into the electronic entry forms confirmation of the proof of completion of the performance of transaction conditions by the receiver and the intermediary verifies the sender's confirmation of the proof of completion of the performance transaction conditions entered by the receiver.

The intermediary notifies the receiver that withdrawal of the payment for goods and/or services is available to the receiver. The receiver then requests from the intermediary payment for the goods and/or services. The intermediary then sends, over the network, payment for the goods and services to the receiver. The intermediary then notifies the sender and the receiver of the proof of completion of the performance of the transaction conditions by both the sender and the receiver.

If the sender a) notifies the receiver, over the network through the intermediary, of no delivery of goods and/or services by the receiver to the sender and b) if the sender receives no response back from the receiver after notifying the receiver, within a period of time specified in the transaction conditions, the sender c) may request, over the network, from the intermediary return of the sender's payment for goods and/or services to the sender and d) the intermediary will send, over the network, the payment for goods and/or services to the sender.

If the receiver a) notifies the sender, over the network through the intermediary, of delivery of goods and/or services by the receiver to the sender, and b) the receiver receives no response from the sender after notifying the sender through the intermediary, within a period of time specified in the transaction conditions, the receiver c) may request, over the network, from the intermediary payment to the receiver for the delivery of the goods and/or services, and d) the intermediary will send, over the network, the payment for goods and/or services to the receiver.

If a) the receiver delivers the goods and/or services to the sender within a period of time specified in the transaction conditions, b) the receiver gives no notice to the sender through the intermediary within a period of time after the delivery of goods and/or services specified in the transaction conditions, of the delivery of goods and/or services to the sender, and c) the receiver receives no notification from the sender, through the intermediary, within a period of time after the delivery of goods and services specified in transaction conditions, that goods and/or services from the receiver are received by the sender, the receiver may d) request through the intermediary payment to the receiver for the delivery of the goods and/or services, and 5) the intermediary will send, over the network, the payment for goods and services to the receiver.

An advantage of the method and system of this disclosure is that the sender and the receiver can create their own transaction conditions for the purchase and delivery of products and/or services.

Another advantage is that the sender is guaranteed receipt of products and/or services prior to the release of payment to the receiver and the receiver is guaranteed payment for delivery of products and/or services without disputes.

Another advantage is that the intermediary can enforce the transaction conditions.

Another advantage is multi confirmation and verification of transaction conditions, first when the transaction conditions are created and sent to the intermediary, again when the transaction conditions are accepted or updated by the receiver and sent to the intermediary, again when transaction conditions are completed and again when proof of completion is confirmed.

Another advantage is that all sender and receiver data related to the purchase of the goods and/or services is recorded and stored by the intermediary.

Another advantage is the sender and receiver are treated equally and there is no bias towards the sender or receiver.

### BRIEF DESCRIPTION OF THE DRAWINGS

FIG. 1 shows a block diagram of a computer network system for implementing the intermediary transaction systems and methods of this disclosure.

FIG. 2 provides a schematic block diagram of an exemplary computer system for an intermediary, a sender, and a receiver for communicating in the intermediary transaction systems and methods of this disclosure.

FIGS. 3A and 3B is a flow chart showing a method of creating and implementing a purchase agreement (transaction) by a purchaser (sender) for goods and/or services through a website of an intermediary over a computer network, such as the Internet.

FIG. 4 shows a main page for entry by a sender to authorize an intermediary to provide services to the sender for the purchase of products and/or services from a receiver.

FIG. 5 shows a main page for a sender that is an individual if the sender selects “individual’ from the main page of FIG. 4.

FIG. 6 shows a main page for a sender that is a company if the sender selects “company” from the main page of FIG. 4.

FIG. 7 shows a face capture page for entering a photo of the face of a sender.

FIG. 8 shows an authorization page for the sender to give authorization to the intermediary.

FIG. 9 shows a receiver main page selection for entry of information on a receiver.

FIG. 10 shows a page for entry of information for a receiver that is an individual.

FIG. 11 shows a page for entry of information for a receiver that is a company.

FIG. 12 shows a page for entry of purchase details by the sender.

FIG. 13 shows a page for entry of product details by the sender.

FIG. 14 shows a page for entry of service details by the sender.

FIG. 15 shows a page for entry of other purchases by the sender.

FIG. 16 shows a page for entry of money transfer details by the sender.

FIG. 17 shows a page for entry of bill payment details by the sender.

FIG. 18 shows a page for entry of payment terms by the sender.

FIG. 19 shows a summary page of the terms and conditions of the transaction.

FIG. 20 shows a payment payout page for the entry of an added payout options by the sender.

FIG. 21 shows a page having a summary of the payment request and for confirmation of the transaction by the sender.

FIG. 22 shows a payment page summary for the sender.

FIG. 23 shows a payment payout page summary for the sender.

FIG. 24 shows a payment method page for the sender.

FIG. 25 shows an agreement transaction summary status selection page for the sender.

FIG. 26 shows a product upload page for the sender.

FIG. 27 shows a service upload page for the sender.

FIG. 28 shows another purchases upload page for the sender.

FIG. 29 shows an updates page for the sender.

FIG. 30 shows a confirmations page for the sender.

FIG. 31 shows a completions page for the sender.

FIG. 32 shows a notification page for a receiver.

FIG. 33 shows a main page for a receiver.

FIG. 34 shows a face capture page for a receiver.

FIG. 35 shows a receiver authorization page.

FIG. 36 shows a purchases and transfer selection page for a receiver.

FIG. 37 shows a product page for a receiver.

FIG. 38 shows a service page for a receiver.

FIG. 39 shows another purchases page for a receiver.

FIG. 40 shows a money transfer page for a receiver.

FIG. 41 shows a bill payment page for a receiver.

FIG. 42 shows a payment terms page for a receiver.

FIG. 43 shows a purchases and transfer agreement transaction summary for a receiver.

FIG. 44 shows a payment page for a receiver.

FIG. 45 shows a payment request page summary for a receiver.

FIG. 46 shows a payment page summary for a receiver.

FIG. 47 shows a payment payout page summary for a receiver.

FIG. 48 shows a payment method page for a receiver.

FIG. 49 shows an agreement transaction summary status selection page for a receiver.

FIG. 50 shows a product upload page for a receiver.

FIG. 51 shows a service upload page for a receiver.

FIG. 52 shows another purchases upload page for a receiver.

FIG. 53 shows an updates page for a receiver.

FIG. 54 shows a confirmations page for a receiver.

FIG. 55 shows a completions page for a receiver.

### DETAILED DESCRIPTION OF THE DISCLOSURE

While the following description details the preferred embodiments of the system and method of the disclosure, it is to be understood that the system and method are not limited in their application to the details of arrangement of the parts or steps of the methods illustrated in the accompanying figures, since the system and method are capable of other embodiments and of being practiced in various ways.

The transaction provided by the system and method of this disclosure represents an exchange of money for goods and/or services. One party to the transaction is a purchaser, referred to herein as a sender, as in a sender of payment. The other party is a provider of goods or services, referred to herein as a receiver, as in a receiver of payment. The sender is responsible for making payment to the receiver and the receiver is responsible for providing the goods and/or services to the sender. When the sender enters the transaction conditions into transaction conditions and makes payment to an intermediary, the sender now confirms the transaction conditions, which has the effect of signing the transaction. The sender fulfills the sender's part of the transaction conditions by providing payment to the intermediary. The receiver accepts the transaction conditions by confirming the conditions of the transaction conditions and then fulfilling the receiver's part of the transaction conditions by completing or providing the goods and/or services to the sender.

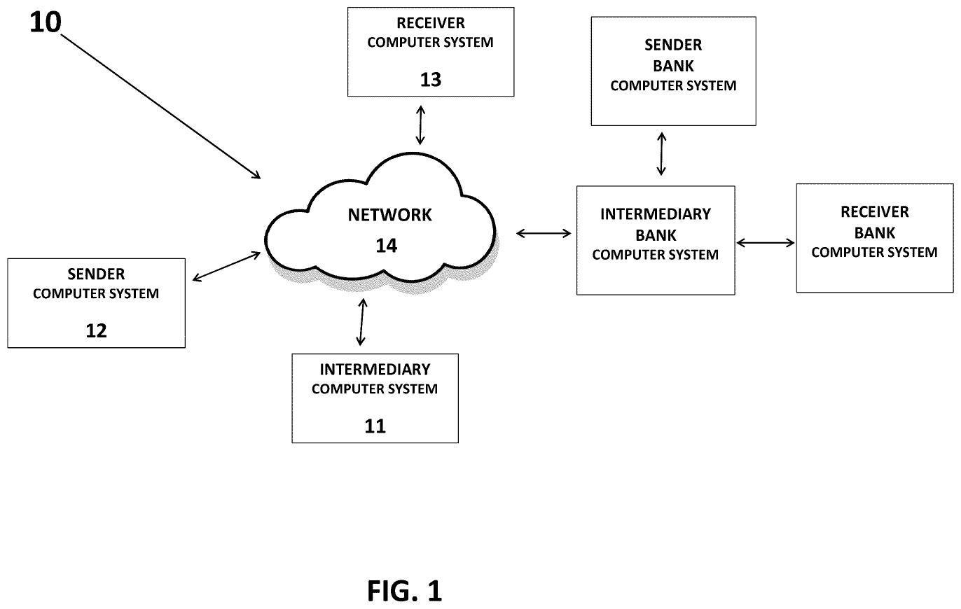

FIG. 1 shows a block diagram of a computer network system 10 for implementing the intermediary transaction systems and methods of this disclosure. An intermediary computer system 11, a sender computer system 12, and a receiver computer system 13 are connected to a network 14, such as the Internet, and communicate with each other through the network 14. The intermediary computer system 11 communicates through the network with its intermediary bank computer system 15. The intermediary bank computer system 15 communicates with the sender's bank computer system 16 and the receiver's bank computer system 17, preferably through the Internet.

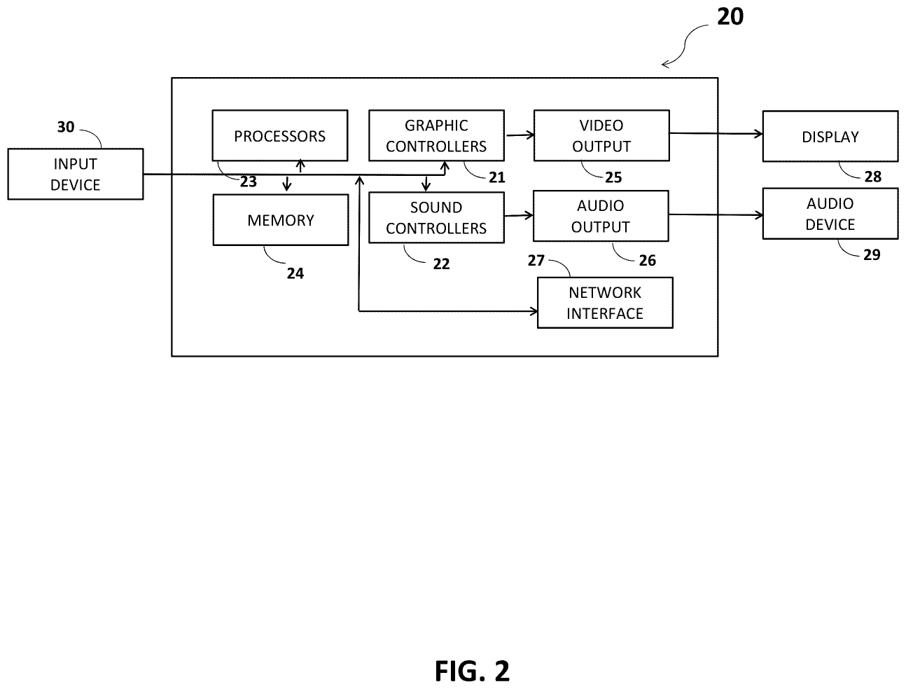

FIG. 2 provides a schematic block diagram of an exemplary computer system 20 for an intermediary, a sender, and a receiver for communicating in the intermediary transaction systems and methods of this disclosure. All the blocks shown are implemented by suitable circuitry and may be implemented in hardware and/or software. The computer system 20 has a graphics controller 21 and a sound controller 22. The graphics controller 21 and sound controller 22 are provided by one or more processors 23 and computer storage and memory 24. Computer storage media and memory 24 has computer executable instructions stored thereon which, when executed by one or more processors 23, cause the processors 23 to execute the computer-implemented method of this disclosure for online intermediary transactions. The graphics controller 21 is configured to provide a video and graphics output 25. The sound controller 22 is configured to provide an audio output 26. The computer system 20 has a network interface 27 allowing the computer system 20 to communicate with a network such as the Internet or other communication infrastructure. The video and graphics output 25 is provided to a display 28. The audio output 26 is provided to an audio device 29 such as a speaker and/or earphones. The computer 20 has an input device 30 which can take any suitable format and can be one or more keyboards, audio input, mouse, and touch screen. The computer system 20 is shown by way of example only. In alternative embodiments, one or more of the parts may be omitted. Alternatively, or additionally, some embodiments may comprise one or more other parts. Alternatively, or additionally, one or more parts may be combined.

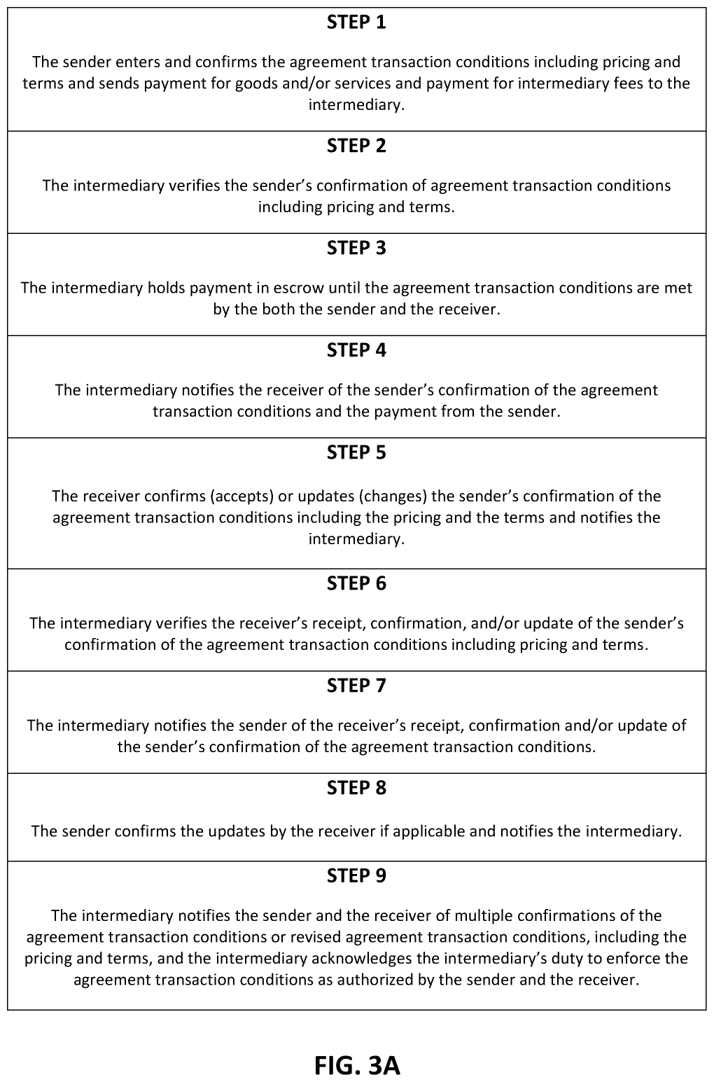

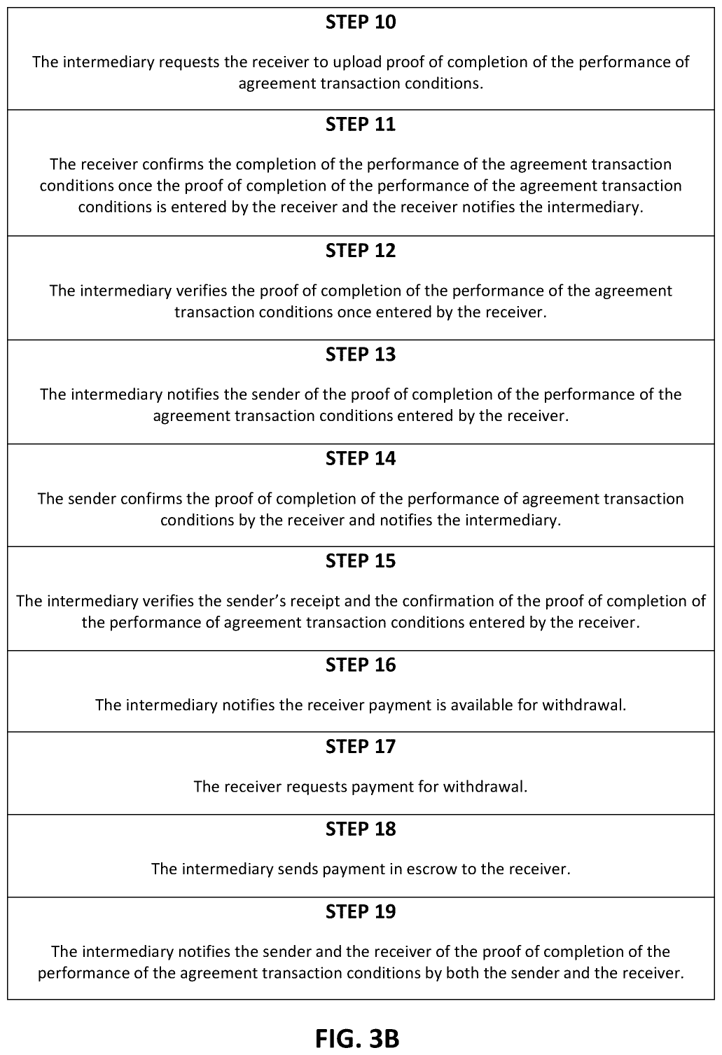

FIGS. 3A and 3B is a flow chart showing a method of this disclosure for creating and implementing a transaction by a purchaser (sender) for goods and/or services through a website of an intermediary over a computer network, such as the Internet. The intermediary's website and computer system 11 provide the method of this disclosure of an intermediary service to initiate and complete the purchase of goods and/or services from a provider (receiver) of goods and/or services. A sender using the sender's computer system 12 logs into the website of an intermediary for purchase and delivery transactions. The sender requests through the website a purchase transaction, enters transaction conditions and terms into an electronic entry form, and enters a confirmation of the transaction into the electronic entry form. Confirming the transaction conditions by the sender is equivalent to the sender providing the sender's signature to the transaction. The sender also sends payment for services and/or product and payment for intermediary fees to the intermediary. (Step 1). The intermediary verifies the sender's confirmation of transaction conditions, including pricing and terms (Step 2). Verification includes documenting and/or recording sender's confirmation of the request and transaction conditions. The intermediary holds payment in an escrow account until transaction conditions are met by both the sender and the receiver (Step 3). The intermediary notifies the receiver through the network 14 and the receiver's computer system 13 of the sender's confirmation of transaction conditions and payment from the sender (Step 4). The receiver confirms (accepts) or updates changes to the sender's transaction conditions including pricing and terms and notifies the intermediary (Step 5). Confirming the transaction conditions by the receiver is equivalent to the receiver providing receiver's signature to the transaction conditions. Updating the transaction conditions by the receiver includes modification of the sender's terms by the receiver. The intermediary verifies receivers receipt, confirmation, and/or update of the sender's confirmation of transaction conditions, including pricing and terms (Step 6). The intermediary notifies the sender of the receiver's receipt, confirmation, and/or update of the sender's confirmation of transaction conditions (Step 7). The sender confirms the updates by the receiver, if applicable, and notifies the intermediary (Step 8).

The intermediary notifies the sender and the receiver of multiple confirmations of transaction conditions or updated (revised) transaction conditions, including pricing and terms, and the intermediary acknowledges the intermediary's duty to enforce the agreement transaction conditions as authorized by the sender and the receiver (Step 9). The intermediary requests the receiver to upload proof of completion of performance of the transaction conditions (Step 10). The receiver confirms completion of the performance of the transaction conditions once proof of completion of the performance of transaction conditions is entered by the receiver and once the receiver notifies the intermediary of completion of the performance of transaction conditions (Step 11). The intermediary verifies proof of completion of the performance of transaction conditions once the proof of completion is entered by the receiver (Step 12). The intermediary notifies the sender of proof of completion of the performance of transaction conditions entered by the receiver into an electronic entry form (Step 13). The sender confirms the proof of completion of the performance of transaction conditions by the receiver and notifies the intermediary (Step 14). The intermediary verifies the sender's receipt and confirmation of the proof of completion of the performance of transaction conditions entered by the receiver into an electronic entry form (Step 15). The intermediary then notifies the receiver that payment is available for withdrawal (Step 16), the receiver requests payment for withdrawal (Step 17), and the intermediary sends payment in escrow to the receiver (Step 18). The intermediary then notifies the sender and the receiver of the proof of completion of the performance of the transaction conditions by both the sender and the receiver (Step 19).

If the sender notifies the receiver through the intermediary, before or after an agreed upon completion date, that no goods or services have been delivered or completed, and there is no response from the receiver within a specified period of time after notification, for example 24 hours, then the sender may request from the intermediary the withdrawal of payment. Under these conditions the intermediary will return payment to the sender if no goods or services have been delivered or completed. If the receiver notifies the sender through the intermediary, before or after an agreed upon completion date, that goods or services have been delivered or completed, and there is no response from the sender within a specified period of time after notification, for example 24 hours, then the receiver may request from the intermediary receipt of the payment. Under these conditions the intermediary will provide payment to the receiver if goods or services have been delivered or completed.

If within a period of time, for example 24 hours, after the completion date the receiver has not given notice to the intermediary of delivery of goods or completion of services and there is no notification to the intermediary from the sender that there is delivery of goods or completion of services, then the receiver can request payment from the intermediary, in which case the intermediary will provide payment to the receiver. The sender or the receiver may cancel the transaction any time before the delivery of goods or completion of services and the sender may request and receive return of the payment.

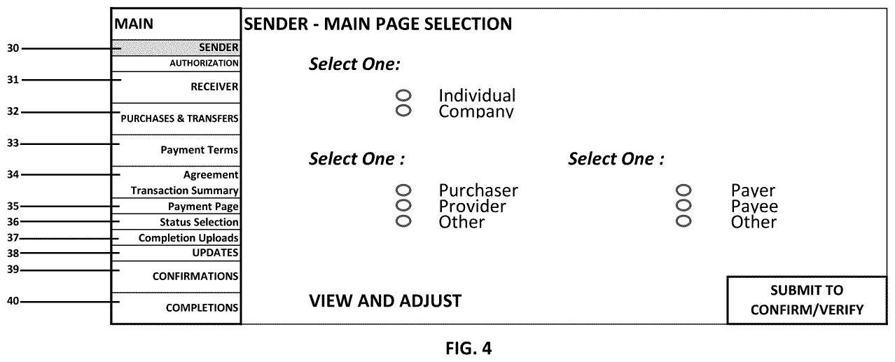

When a sender or receiver logs into the intermediary's website using the sender computer system 12 or the receiver computer system 13, the sender or receiver may request the services of the intermediary for a fee. Various pages or entry forms are presented to the displays 28 of the computer systems of the sender and the receiver by the intermediary's computer system 11 to initiate purchase transactions and complete purchase transactions according to the purchase transaction conditions. Examples of the entry forms (pages) are shown in FIGS. 4-55. Various selection icons on the pages allow for entry and or review of information and data when selected by the sender or receiver through their computer systems. The sender icon 30 allows the sender to fill out various forms and to select other selection icons and the receiver icon 31 allows the receiver to fill out various forms and to select other selection icons. The other selection icons include purchases and transfers selection 32, payment terms 33, Agreement Summary 34, payment page 35, status selection 36, completion uploads 37, updates 38, confirmations 39, and completions 40.

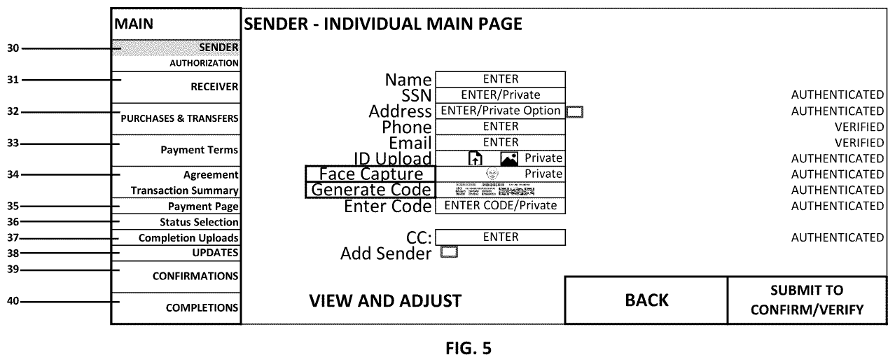

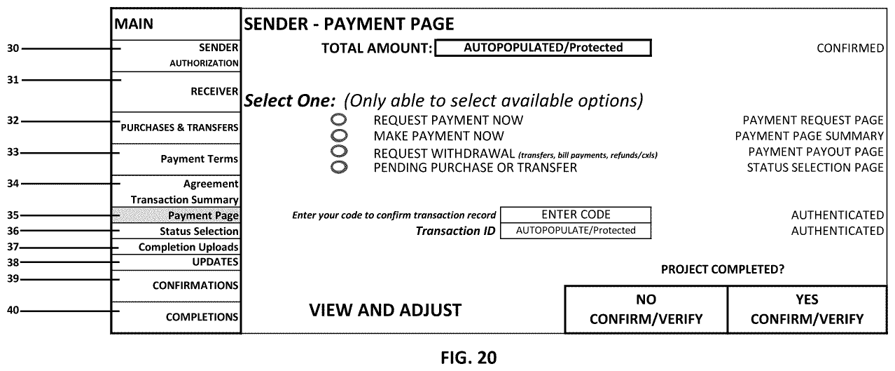

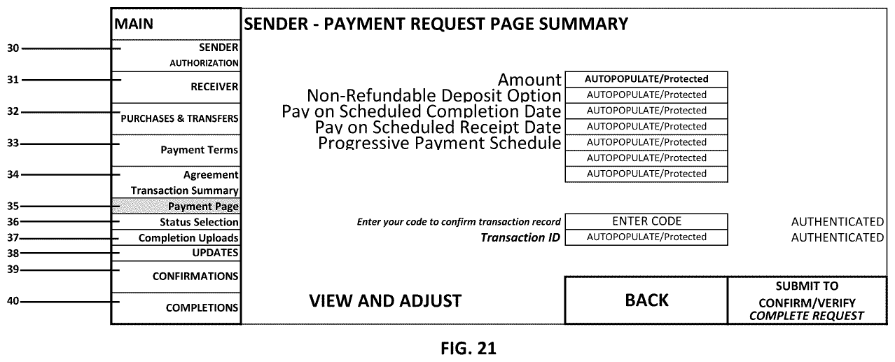

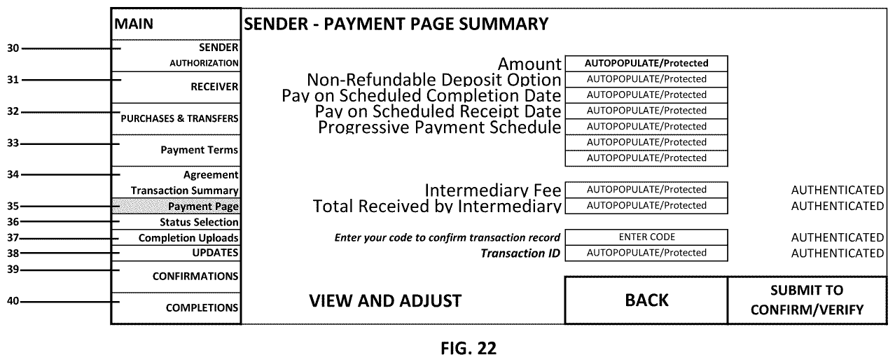

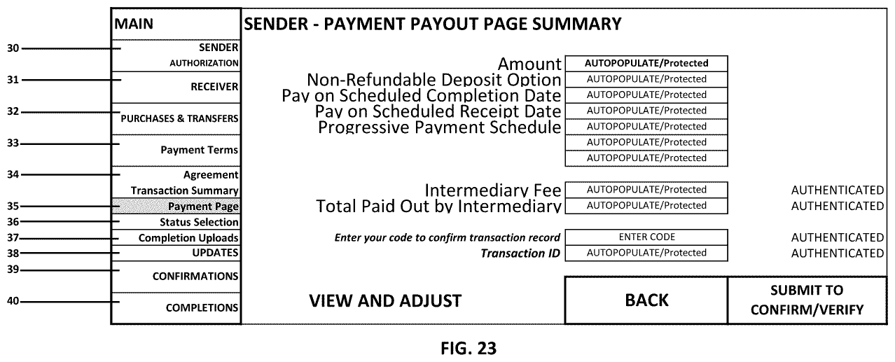

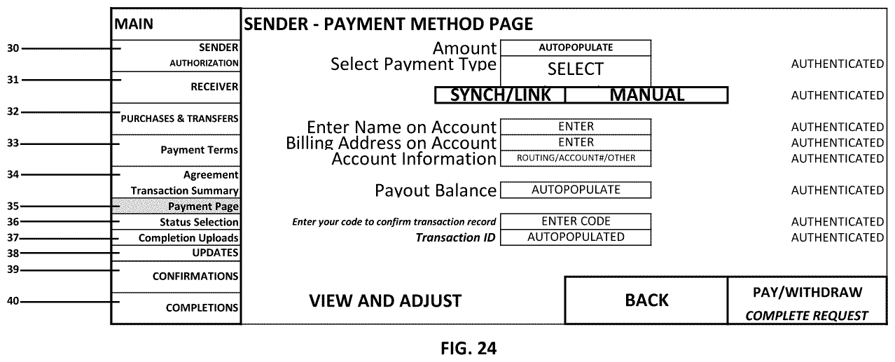

If a sender selects the sender icon 30 for authorizing the intermediary to provide services to the sender a main page is displayed, as shown in FIG. 4. FIG. 4 has sender identifiers to confirm roles and role attributes of the sender which determine page options, confirmation options, and payment and funds accessibility. These identifiers are only available as options for a primary sender. The sender is the initiator of a purchase transaction. Sender and receiver identifiers on both the sender and receiver main page selection pages, if selected, enable senders and receivers to confirm both the transaction conditions and the completion of the transaction conditions. The provider identifier enables access to a payment request page summary (see FIG. 21). Payer and payee identifiers enable access to the payment page (FIG. 20), payment page summary (FIG. 22), payment payout page (FIG. 23), and payment method page (FIG. 24). Sender and receiver identifiers confirm the transaction conditions only and instruct the intermediary to send a notification of transaction completion. The sender and receiver identifiers also enable access to funds for withdrawal. When input into this page is completed, the sender selects “submit to confirm/verify” to confirm the information to be verified by the intermediary. If the sender selects “individual’ a sender individual main page is displayed to the sender, as shown in FIG. 5. The sender enters a name, social security number (private field only known to intermediary), enters an address (private field option if selected), provides an ID upload and face capture upload, and creates and enters a code (private field only known to intermediary). A CC entry is for persons to be copied and instructs the intermediary to whom “view only” records of the agreement transaction conditions summary are sent once the transaction is initiated and then again once completed. If “add sender” is selected an additional sender main page selection is displayed for completion. Once the individual main page is completed the sender selects “submit to confirm/verify” to confirm the information to be verified by the intermediary. The sender selects “back” to return to the previous page.

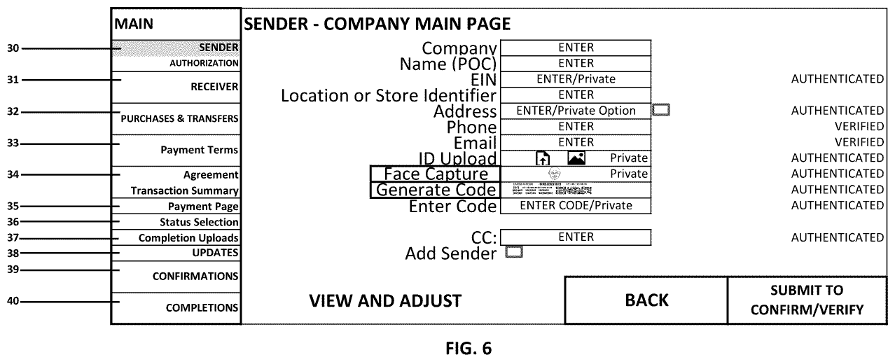

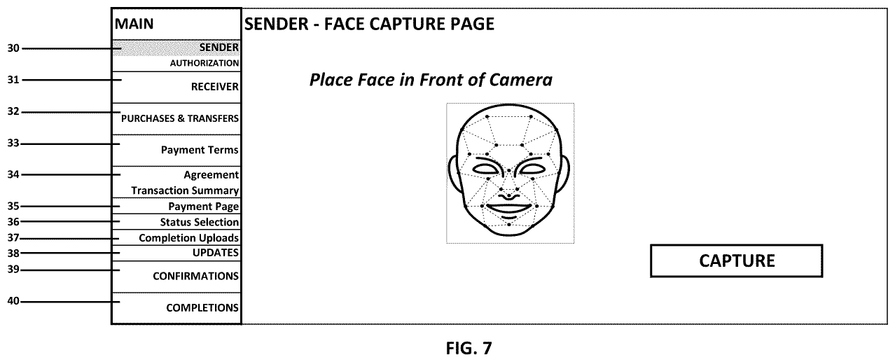

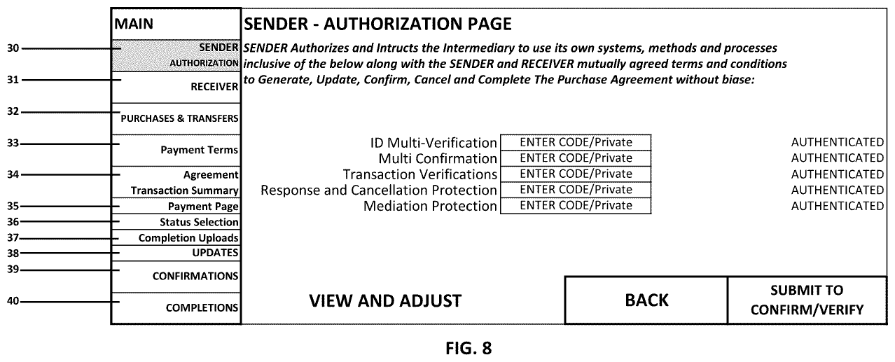

If the sender selects “company” a company main page is displayed as shown in FIG. 6. The sender enters a company name, a point of contact name, the sender's name, an EIN (private field only known to intermediary) and an address (private field option if selected), uploads ID and face capture, and creates and enters a code (private field only known to intermediary). A CC entry instructs the intermediary to whom “view only” records of the agreement summary are sent once the transaction is initiated and then again once completed. If “add sender” is selected an additional sender main page selection is displayed for completion. Once the company main page is completed the sender selects “submit to confirm/verify” to confirm the information to be verified by the intermediary. The sender selects “back” to return to the previous page. A face capture page is displayed as shown in FIG. 7 when the sender selects “face capture” on the individual main page or the company main page. An authorization page is displayed as shown in FIG. 8 when the sender selects “submit to confirm and verify”. The sender authorizes and instructs the intermediary to use the intermediary's systems, methods, and processes along with the sender and receiver mutually agreed upon terms and conditions to generate, update, confirm, cancel, or complete the transaction conditions without bias towards either the sender or the receiver. The sender enters the sender's code where indicated and selects “submits to confirm and verify” for the sender authorization page.

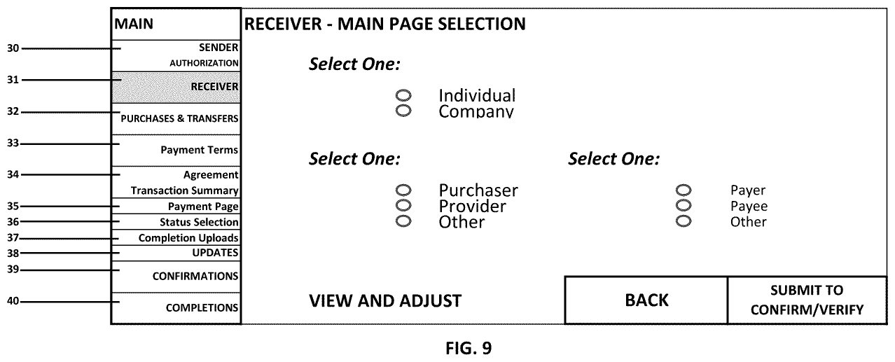

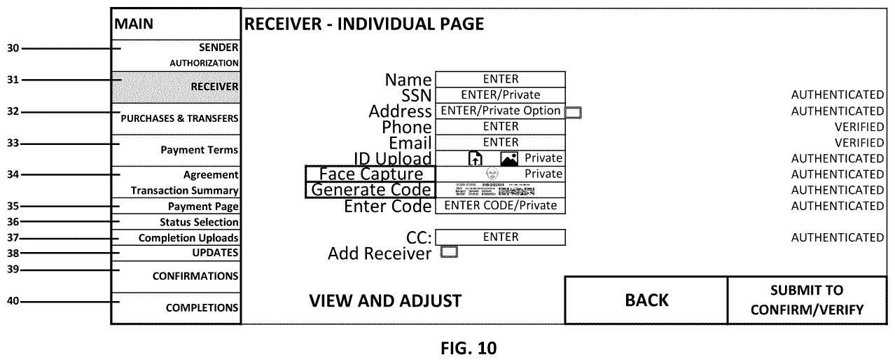

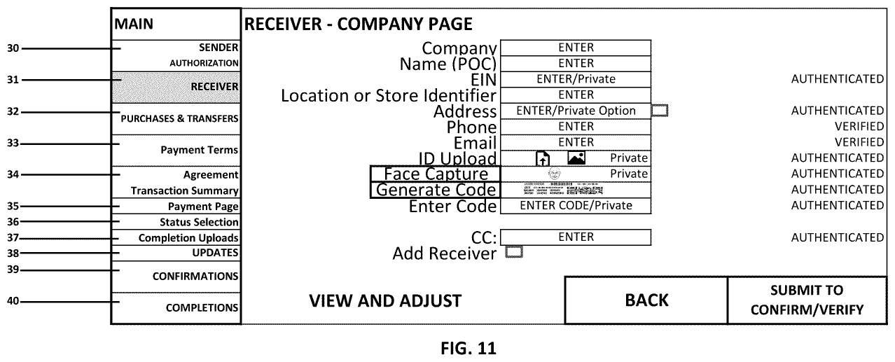

A receiver main page selection is provided to the sender, as shown in FIG. 9. The sender completes and submits this page as described for the sender main page as shown in FIG. 4. If the sender selected “individual” on the receiver main page, a receiver individual page is displayed to the sender, as shown in FIG. 10. The sender completes and submits this page as described for the sender individual main page as shown in FIG. 5. If the sender selected “company” on the receiver main page, a receiver company page is displayed to the receiver, as shown in FIG. 11. The sender completes and submits this page as described for the sender company main page as shown in FIG. 6.

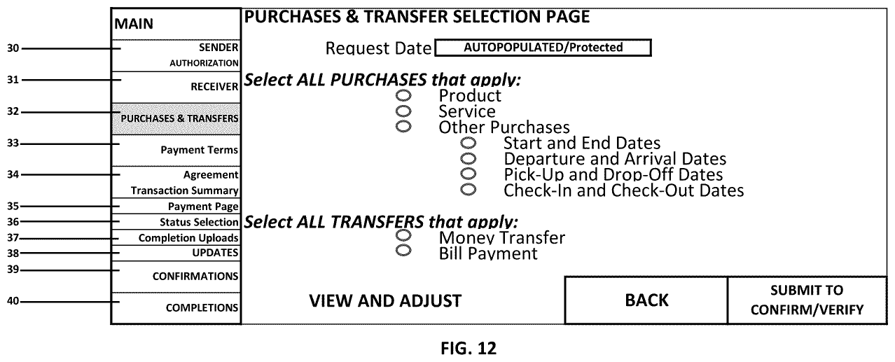

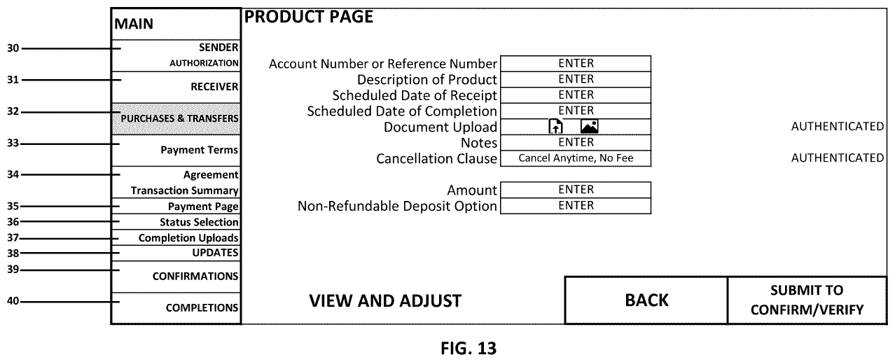

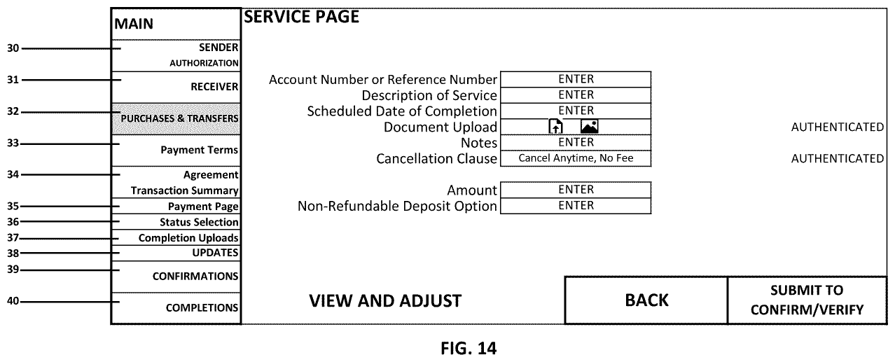

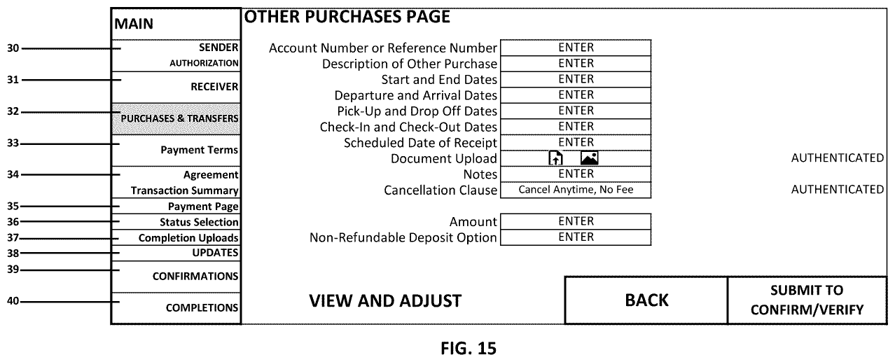

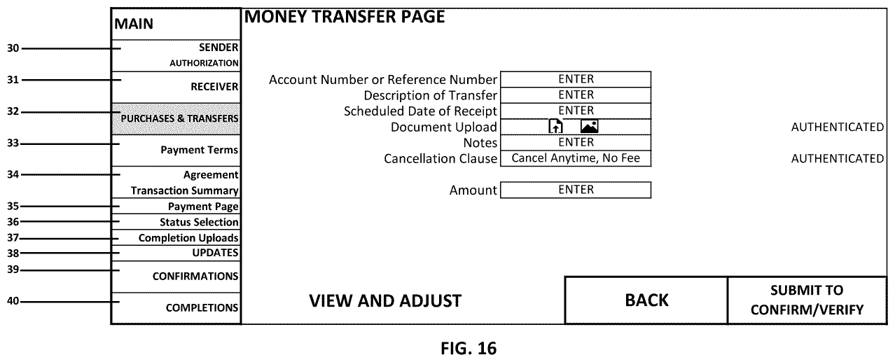

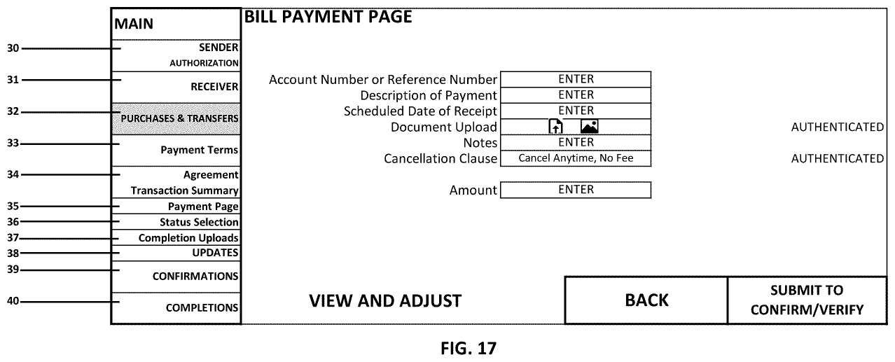

When in the sender authorization mode 30, if the sender selects the purchases and transfers icon 32, a purchase and transfer selection page is displayed to the sender as shown in FIG. 12. The sender selects and enters purchase transaction details and selects “submit to confirm/verify” to confirm the information to be verified by the intermediary. If the sender selected “product” on the purchases and transfer selection page, then a product page is displayed to the sender as shown in FIG. 13. The sender uploads supporting documentation such as invoices, contracts, photos, and the like. Once information is entered the sender selects “submit to confirm/verify” to confirm the information to be verified by the intermediary. If the sender selected “service” on the purchases and transfer selection page, then a service page is displayed to the sender as shown in FIG. 14. The sender completes and submits this page as described for the product page as shown in FIG. 13. If the sender selected “other purchase” on the purchases and transfer selection page, then another services page is displayed to the sender as shown in FIG. 15. The sender completes and submits this page as described for the product page as shown in FIG. 13. If the sender selected “money transfer” on the purchases and transfer selection page, then a money transfer page is displayed to the sender as shown in FIG. 16. The sender completes and submits this page as described for the product page as shown in FIG. 13. If the sender selected “bill payment” on the purchases and transfer selection page, then a bill payment page is displayed to the sender as shown in FIG. 17. The sender completes and submits this page as described for the product page as shown in FIG. 13.

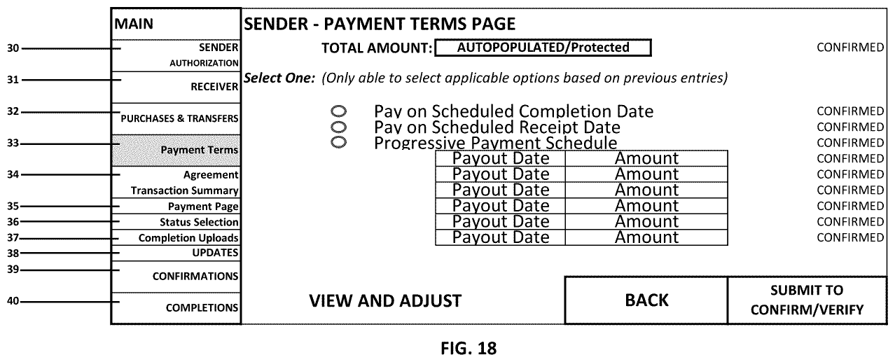

When in the sender authorization mode 30, if the sender selects the payment terms icon 33 a payment terms page is displayed to the sender as shown in FIG. 18. The sender selects and enters added payout options for the transaction if applicable. Once information is entered the sender selects “submit to confirm/verify” to confirm the information to be verified by the intermediary.

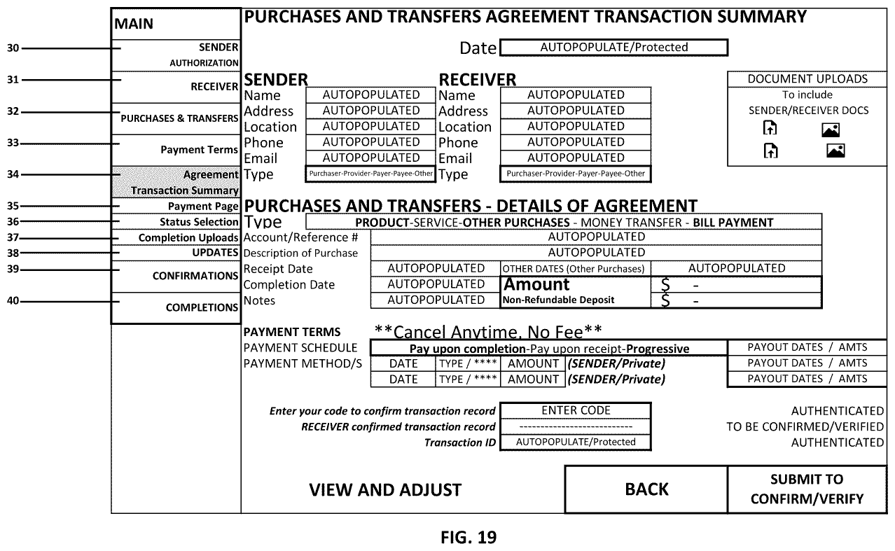

When in the sender authorization mode 30, if the sender selects the agreement transaction summary icon 34 a purchases and transfers agreement transaction summary page is displayed to the sender as shown in FIG. 19. The sender views the purchases and transfers agreement transaction summary (transaction conditions). The sender enters the sender's code and selects “submit to confirm/verify” to confirm the information to be verified by the intermediary.

When in the sender authorization mode 30, if the sender selects the payment page icon 35 a payment page is displayed to the sender as shown in FIG. 20. The sender enters the sender's code and selects and enters added payout options for the transaction where applicable. The sender selects “yes confirm/verify” or “no confirm/verify to confirm project completion status. A payment request page summary is displayed to the sender as shown in FIG. 21 if applicable identifier options are selected. The sender enters the sender's code and completes confirmation of the transaction. The sender selects “submit to confirm/verify” to confirm the information to be verified by the intermediary. A payment page summary is displayed to the sender for the sender to continue to confirm the transaction, including intermediary fees, and to enter sender's code to complete confirmation as shown in FIG. 22 if applicable identifier options are selected. The sender selects “submit to confirm/verify” to confirm the information to be verified by the intermediary. A payment payout page summary is displayed to the sender for the sender to continue to confirm the transaction including intermediary fees and to enter sender's code to complete confirmation as shown in FIG. 23 if applicable identifier options are selected. The sender selects “submit to confirm/verify” to confirm the information to be verified by the intermediary. A payment method page is displayed to the sender for the sender to enter sender's code to continue to confirm the transaction, including intermediary fees, and to continue to finalize entry for payment and payout options and complete the confirmation of transaction as shown in FIG. 24. If applicable, identifier options are selected. The sender selects “submit to confirm/verify” to confirm the information to be verified by the intermediary.

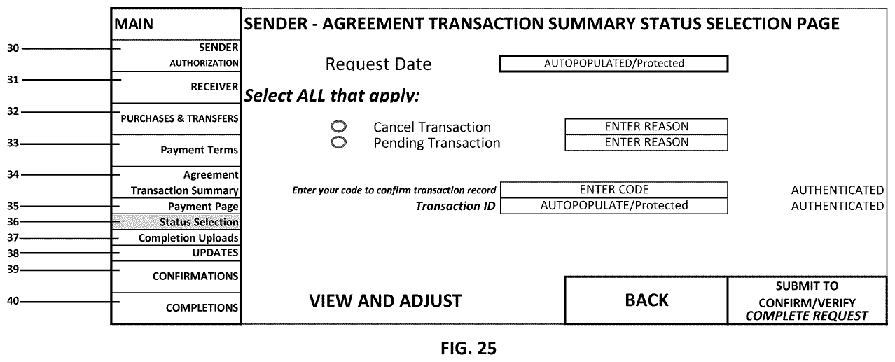

When in the sender authorization mode 30, if the sender selects the status selection icon 36 an agreement transaction summary status selection page is displayed to the sender as shown in FIG. 25. The sender continues to confirm the transaction and advise the intermediary of the transaction status. The sender enters the sender's code and selects “submit to confirm/verify” to confirm the information to be verified by the intermediary.

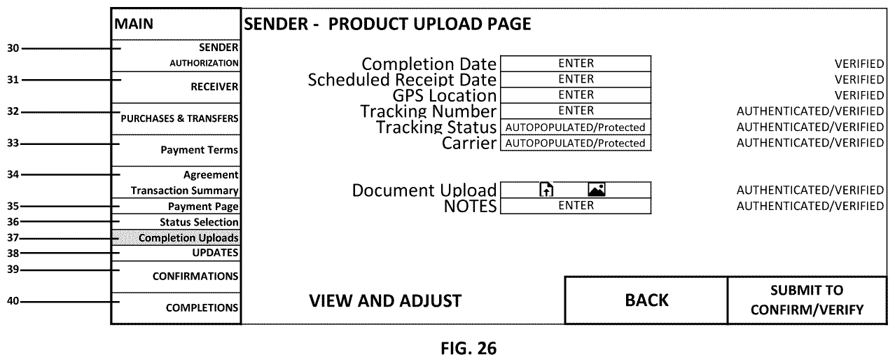

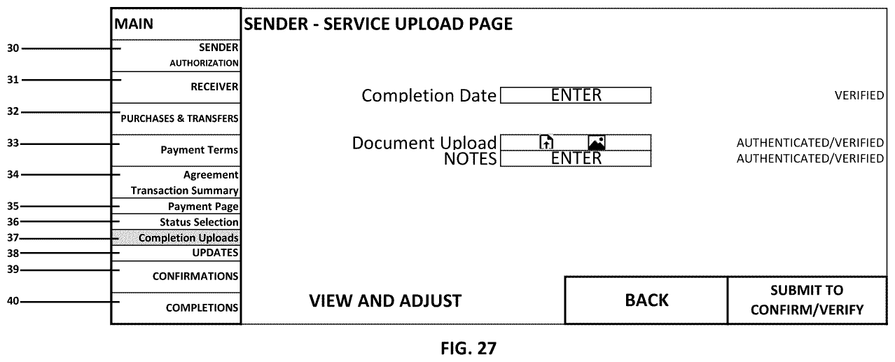

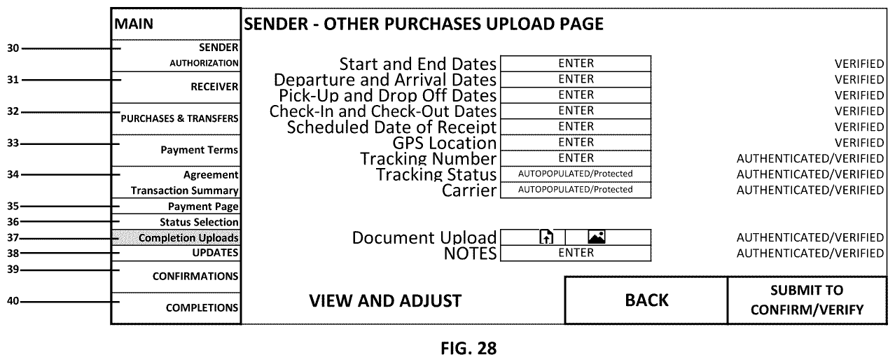

When in the sender authorization mode 30, if the sender selects the completion uploads icon 37 a product upload page is displayed to the sender as shown in FIG. 26. The sender confirms the proof of completion of the transaction conditions for a product and advises the intermediary of completion of the transaction conditions. The sender selects “submit to confirm/verify” to confirm the information to be verified by the intermediary. A service upload page is displayed to the sender as shown in FIG. 27. The sender confirms the proof of completion of the transaction conditions for a service and advises the intermediary of completion of the transaction. The sender selects “submit to confirm/verify” to confirm the information to be verified by the intermediary. An “other purchases” upload page is displayed to the sender as shown in FIG. 28. The sender confirms the proof of completion of the other purchases transaction and advises the intermediary of completion of the transaction conditions. The sender selects “submit to confirm/verify” to confirm the information to be verified by the intermediary.

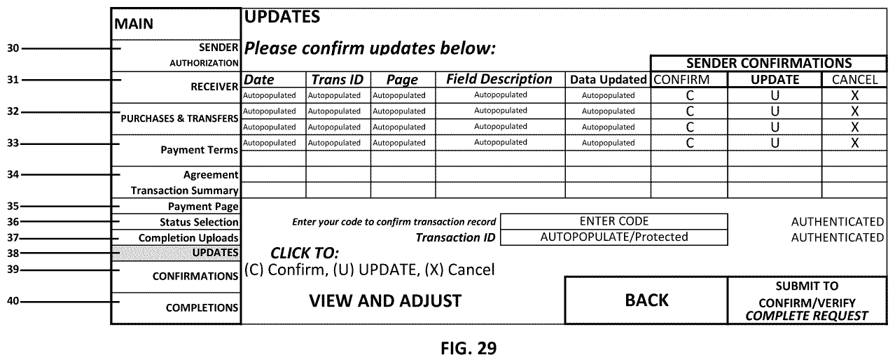

When in the sender authorization mode 30, if the sender selects the updates icon 38 an updates page is displayed to the sender as shown in FIG. 29. This icon is an alert/action icon where the sender receives transaction updates, confirms transaction updates, updates transaction updates, or cancels the transaction. The sender enters their code and selects “submit to confirm/verify” to confirm the information to be verified by the intermediary.

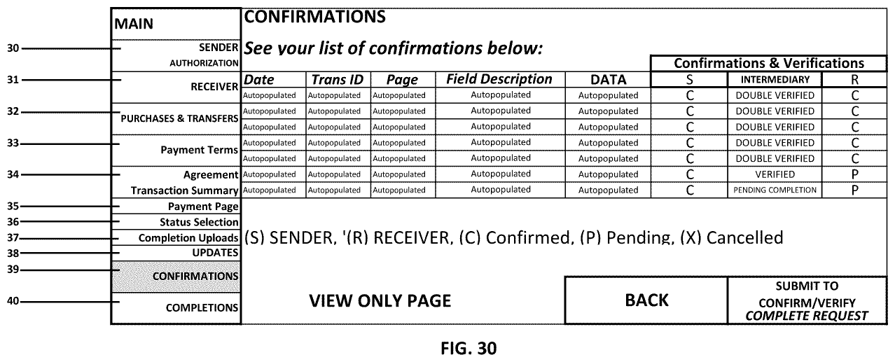

When in the sender authorization mode 30, if the sender selects the confirmations icon 39 a confirmation page is displayed to the sender as shown in FIG. 30. The sender views the transaction confirmations, updates, cancellations, and pending transaction records. The sender selects “submit to confirm/verify” to confirm the information to be verified by the intermediary.

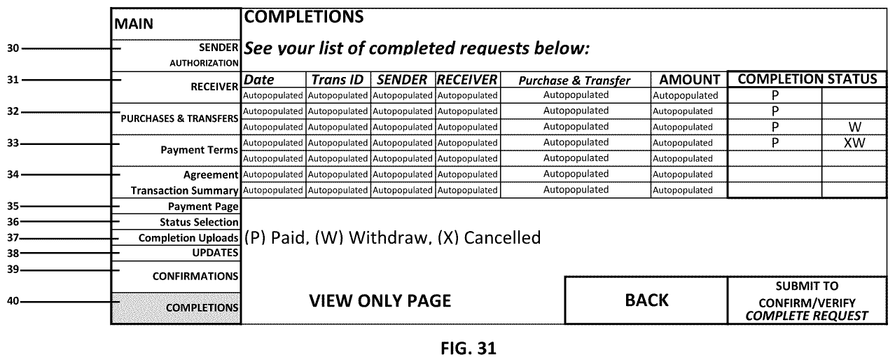

When in the sender authorization mode 30, if the sender selects the completions icon 40 a completions page is displayed to the sender as shown in FIG. 31. The sender views the completed transactions, transaction records, and status. The sender selects “submit to confirm/verify” to confirm the information to be verified by the intermediary.

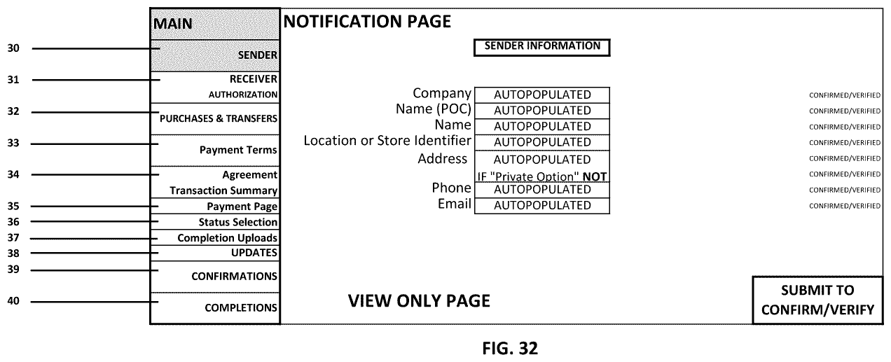

The intermediary can send a notification page to the receiver as shown in FIG. 32. The notification page includes the senders' confirmed, verified, and authorized information for disclosure. The receiver selects “submit to confirm/verify” to confirm the information to be verified by the intermediary.

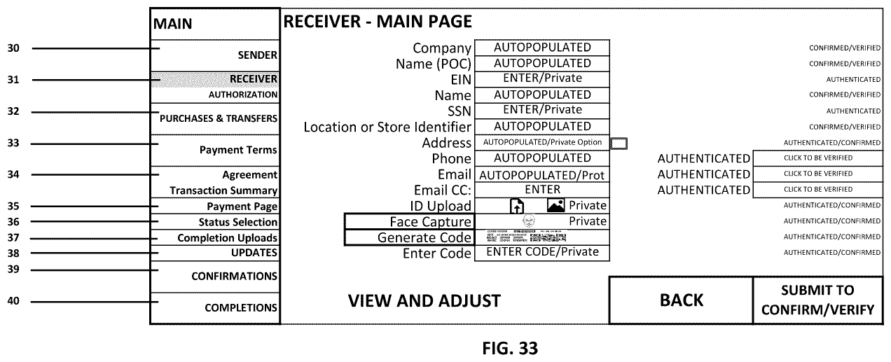

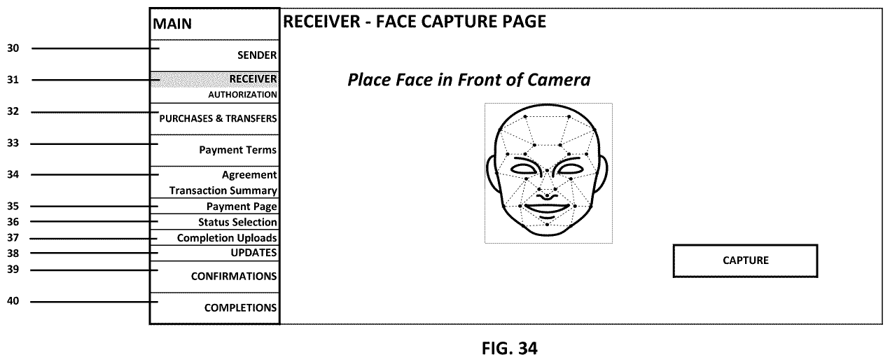

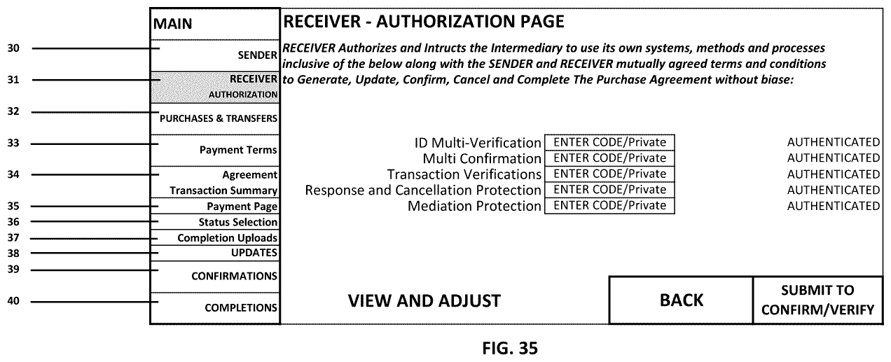

If a receiver selects the receiver icon 31 for authorizing the intermediary to provide services to the receiver a receiver main page for an individual or company is displayed, as shown in FIG. 33. The page is displayed because of selecting “provider” on the receiver main page selection. The “view and adjust” icon includes senders confirmed and verified information for the receiver. The company name, point of contact name, the receiver's name, SSN/EIN (private field only known to intermediary), address (private option), email, phone number, and code (a private field only known to intermediary and used to create, confirm, update, or cancel the transaction) of the receiver are entered or adjusted. ID upload and face capture are entered. A CC entry includes persons to be copied and instructs the intermediary which persons to be copied and which persons may only view records once the transaction is initiated and then again once completed. The receiver selects “submit to confirm/verify” to confirm the information to be verified by the intermediary. A face capture page is displayed to the receiver as shown in FIG. 34 and the “capture” icon is selected. A receiver authorization page is displayed to the receiver as shown in FIG. 35. The receiver authorizes and instructs the intermediary to use the intermediary's systems, methods, and processes along with the sender and the receiver mutually agreed upon terms and conditions to generate, update, confirm, cancel, or complete the transaction conditions without bias towards either the sender or the receiver when the receiver enters the receiver's code where indicated and submits to confirm and verify the receiver authorization page.

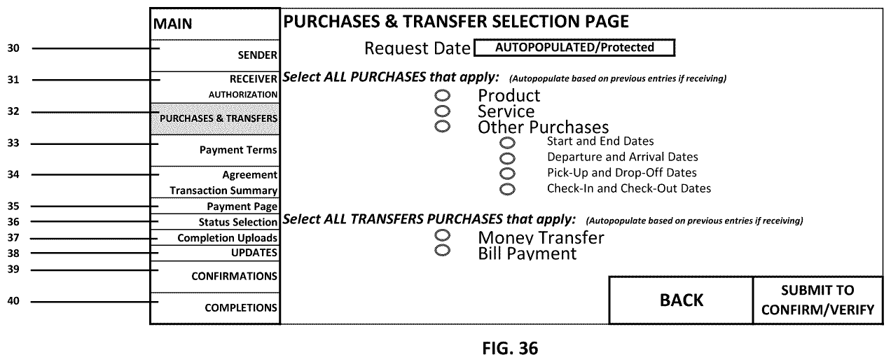

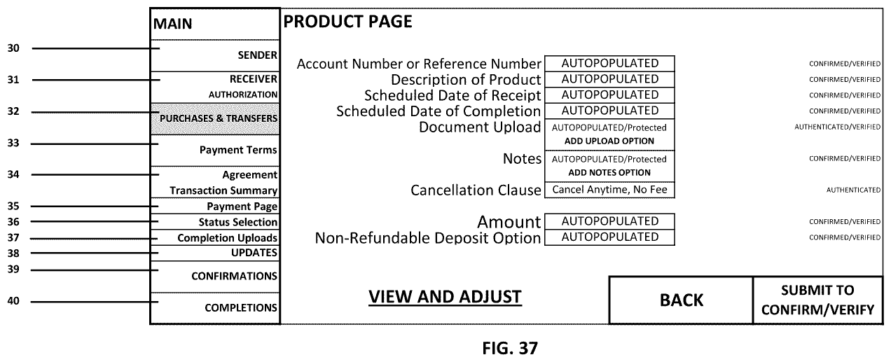

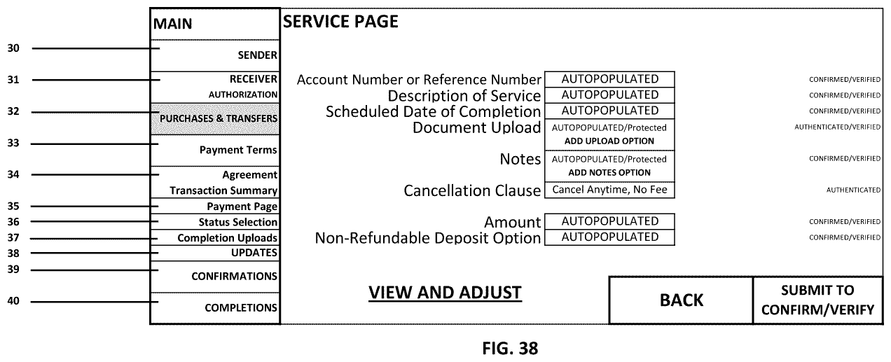

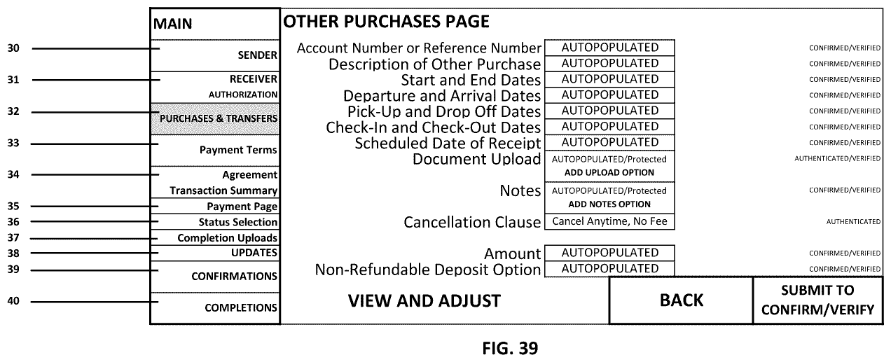

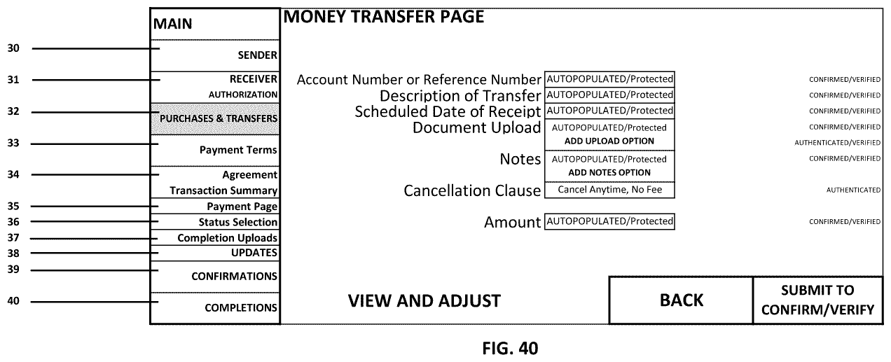

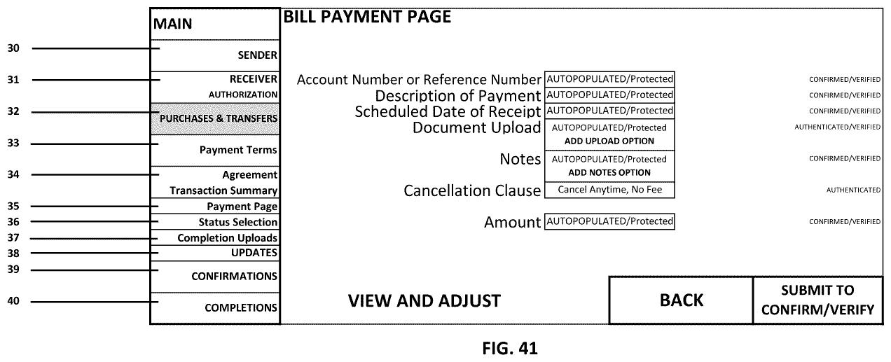

When in the receiver authorization mode 31, if the receiver selects the purchases and transfers icon 32 a purchases and transfers selection page is displayed to the receiver as shown in FIG. 36. This page provides access to the sender's confirmed and verified information for the transaction conditions. The receiver views, confirms, and, if required, updates the purchase transaction details sent by the sender. The receiver selects “submit to confirm/verify” to confirm the information to be verified by the intermediary. If “product” was selected on the purchases and transfer selection page, then a product page is displayed to the receiver as shown in FIG. 37. A “view and adjust icon” is selected for purchase transaction information and to upload additional documents such as invoices, contracts, photos, etc. (supporting documentation). Once information is entered by the receiver the receiver selects “submit to confirm/verify” to confirm the information to be verified by the intermediary. If “service” was selected on the purchases and transfer selection page, then a service page is displayed to the receiver as shown in FIG. 38. A “view and adjust icon” is selected for service transaction information and to upload additional documents such as invoices, contracts, photos, etc. (supporting documentation). Once information is entered by the receiver the receiver selects “submit to confirm/verify” to confirm the information to be verified by the intermediary. If “other purchases” was selected on the purchases and transfer selection page, then another purchase page is displayed to the receiver as shown in FIG. 39. A “view and adjust icon” is selected for purchase transaction information and to upload additional documents such as invoices, contracts, photos, etc. (supporting documentation). Once information is entered by the receiver the receiver selects “submit to confirm/verify” to confirm the information to be verified by the intermediary. If “money transfer” was selected on the purchases and transfer selection page, then a money transfer page is displayed to the receiver as shown in FIG. 40. A “view and adjust icon” is selected and additional documents such as invoices, contracts, photos, etc. (supporting documentation) are uploaded. Once information is entered by the receiver the receiver selects “submit to confirm/verify” to confirm the information to be verified by the intermediary. If “bill payment” was selected on the purchases and transfer selection page, then a bill payment page is displayed to the receiver as shown in FIG. 41. A “view and adjust icon” is selected and additional documents such as invoices, contracts, photos, etc. (supporting documentation) are uploaded. Once information is entered by the receiver the receiver selects “submit to confirm/verify” to confirm the information to be verified by the intermediary.

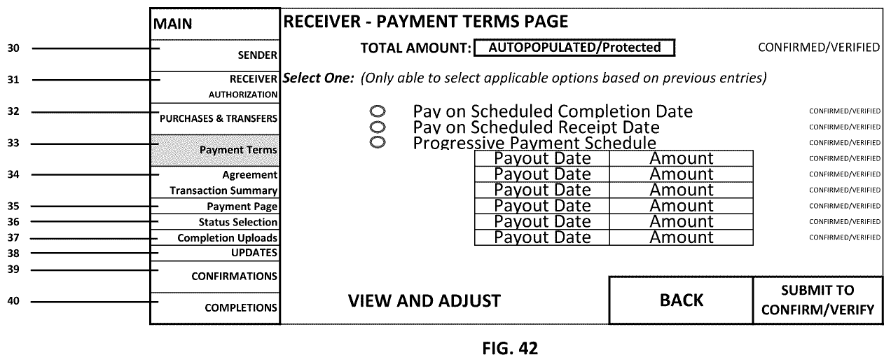

When in the receiver authorization mode 31, if the receiver selects the payment terms icon 33 a payment terms page is displayed to the receiver as shown in FIG. 42. The receiver selects and adjusts added payout options for the transaction if applicable.

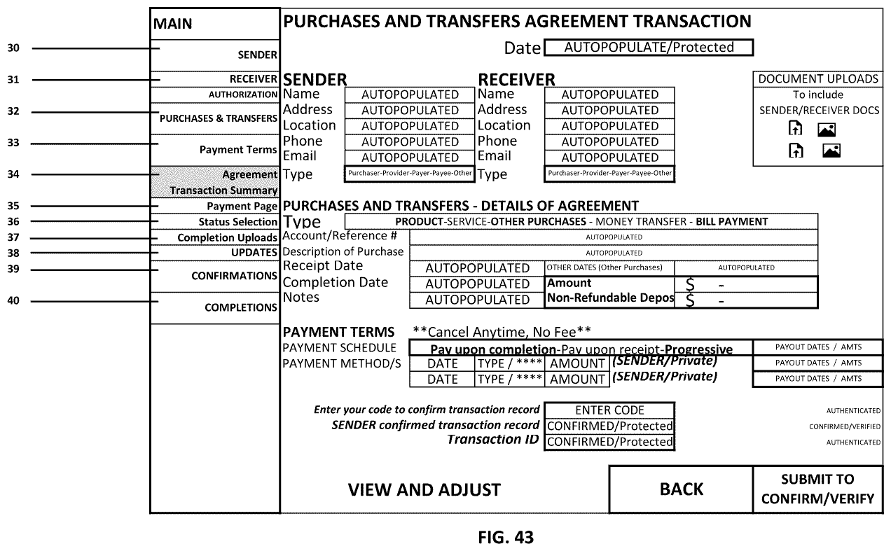

When in the receiver authorization mode 31, if the receiver selects the agreement transaction summary icon 34 a purchases and transfers agreement transaction summary page is displayed to the receiver as shown in FIG. 43. The receiver views the agreement transaction summary including terms and conditions of the transaction and confirmation of the same by the sender. Once completed, the receiver enters the receiver's code and selects “submit to confirm/verify” to confirm the information to be verified by the intermediary. Once the agreement transaction summary has been confirmed by both the sender and receiver (purchaser/provider) the intermediary notifies all parties according to the identifiers previously selected.

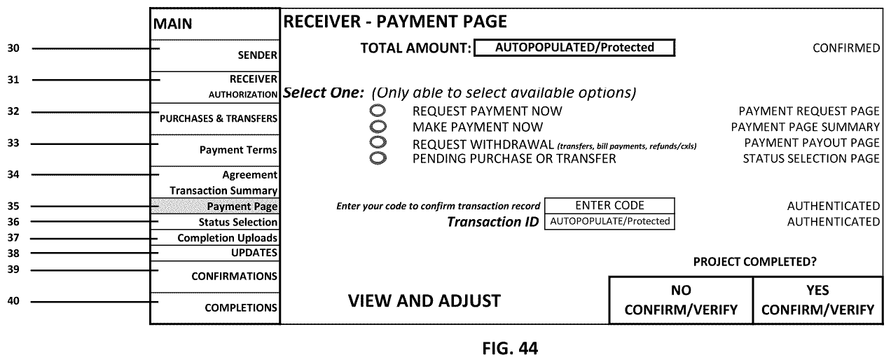

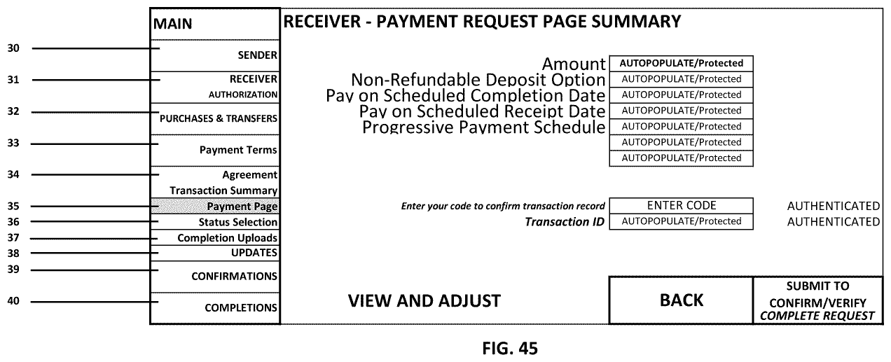

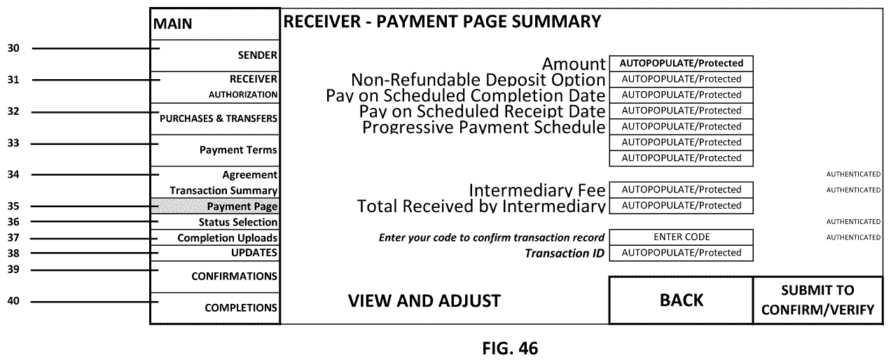

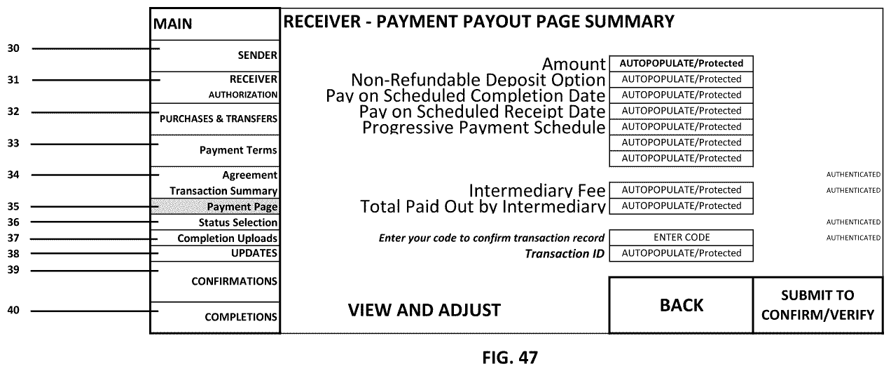

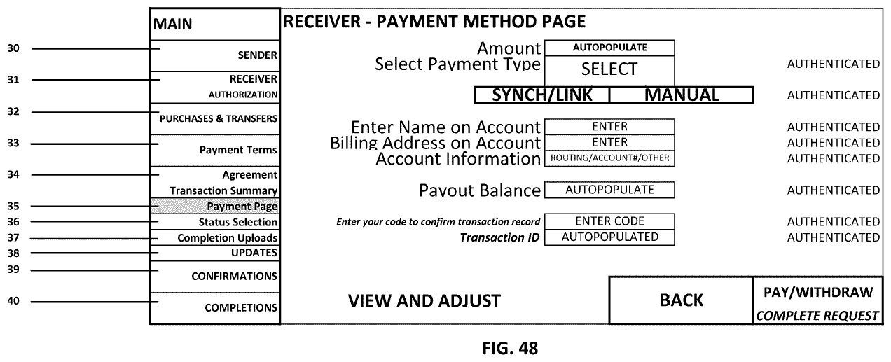

When in the receiver authorization mode 31, if the receiver selects the payment page icon 35 a payment page is displayed to the receiver as shown in FIG. 44. The receiver enters the receiver's code, confirms the transaction, and selects and enters payment and payout options where applicable. Once information is entered by the receiver the receiver selects “submit to confirm/verify” to confirm the information to be verified by the intermediary. The receiver receives a payment request page summary as shown in FIG. 45 if applicable identifier options were previously selected. The receiver enters the receiver's code and completes confirmation of the transaction sent by the sender. Once information is entered by the receiver the receiver selects “submit to confirm/verify” to confirm the information to be verified by the intermediary. The receiver receives a payment page summary, as shown in FIG. 46 if applicable identifier options are selected. The receiver enters the receiver's code and continues to confirm the transaction, including intermediary fees. Once information is entered by the receiver the receiver selects “submit to confirm/verify” to confirm the information to be verified by the intermediary. The receiver receives a payment payout page summary, as shown in FIG. 47 if applicable identifier options are selected. The receiver enters the receiver's code and continues to confirm the transaction. Once information is entered by the receiver the receiver selects “submit to confirm/verify” to confirm the information to be verified by the intermediary. The receiver receives a payment method page, as shown in FIG. 48. If applicable, identifier options are selected. The receiver enters the receiver's code, completes confirmation of the transaction, including intermediary fees, and finalizes entry for payment and payout options. Once information is entered by the receiver the receiver selects “submit to confirm/verify” to confirm the information to be verified by the intermediary.

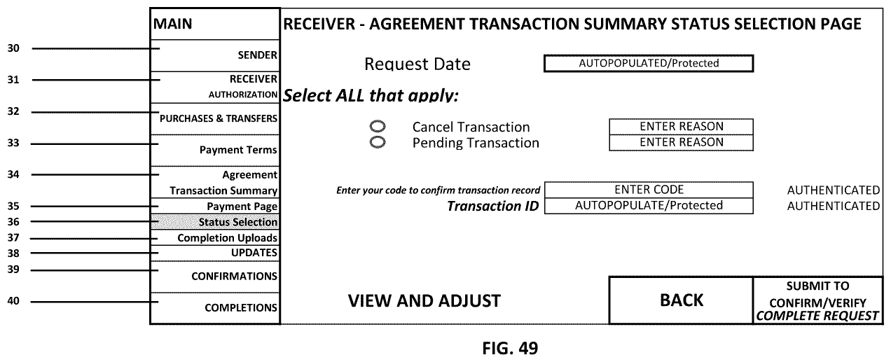

When in the receiver authorization mode 31, if the receiver selects the agreement transaction status selection icon 36 a status selection page is displayed to the receiver as shown in FIG. 49. The receiver continues to confirm the transaction and advise the intermediary of the transaction status. Once completed, the receiver selects “submit to confirm/verify” to confirm the information to be verified by the intermediary.

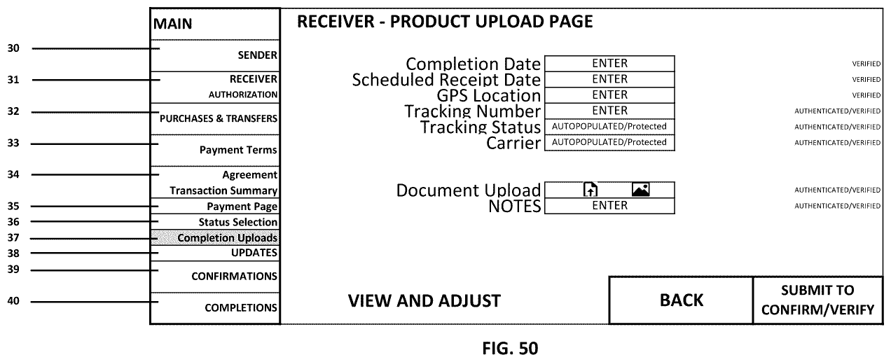

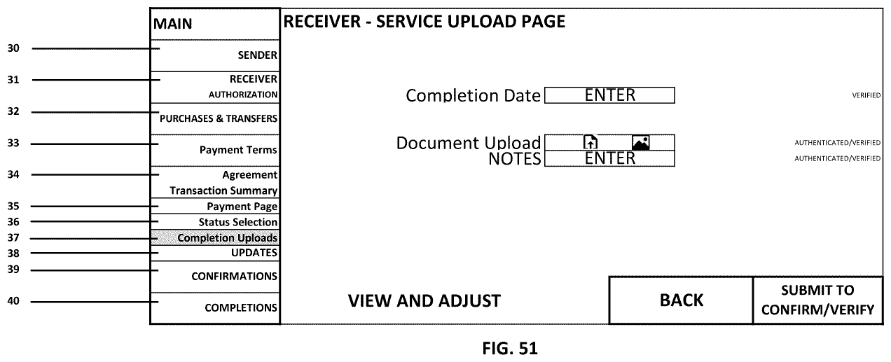

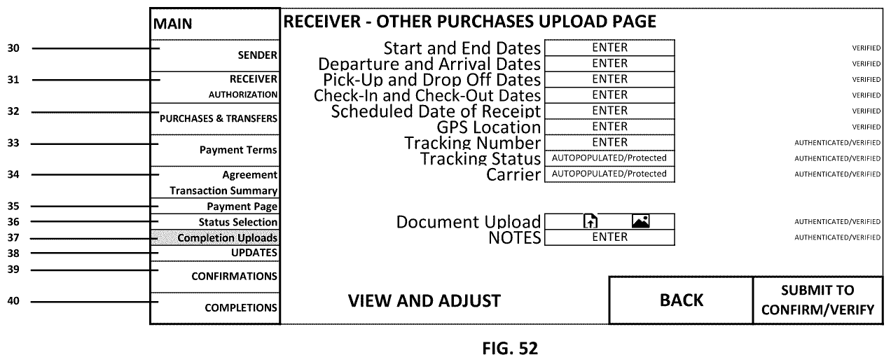

When in the receiver authorization mode 31, if the receiver selects the completion uploads icon 37 a receiver product upload page is displayed to the receiver as shown in FIG. 50. The receiver confirms the proof of transaction completion of the product transaction and advises the intermediary of completion of the transaction status. Once completed, the receiver selects “submit to confirm/verify” to confirm the information to be verified by the intermediary. A receiver service upload page is displayed to the receiver as shown in FIG. 51. The receiver confirms the proof of transaction completion of the service transaction and advises the intermediary of completion of the transaction status. Once completed, the receiver selects “submit to confirm/verify” to confirm the information to be verified by the intermediary. A receiver “other purchases” upload page is displayed to the receiver as shown in FIG. 52. The receiver confirms the proof of transaction completion of the other purchases transaction and advises the intermediary of completion of the transaction status. Once completed, the receiver selects “submit to confirm/verify” to confirm the information to be verified by the intermediary.

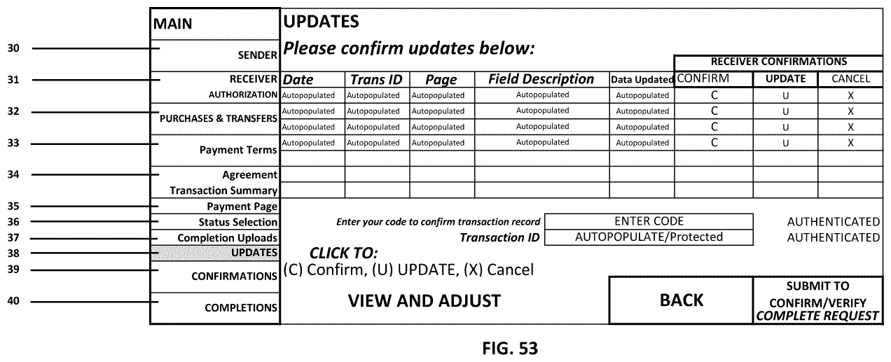

When in the receiver authorization mode 31, if the receiver selects the updates icon 38 an updates page is displayed to the receiver as shown in FIG. 53. This icon is an alert/action icon where the receiver receives transaction conditions updates, confirms the transaction conditions updates, or updates the transaction conditions updates, or cancels the transaction. Once completed, the receiver enters code and selects “submit to confirm/verify” to confirm the information to be verified by the intermediary.

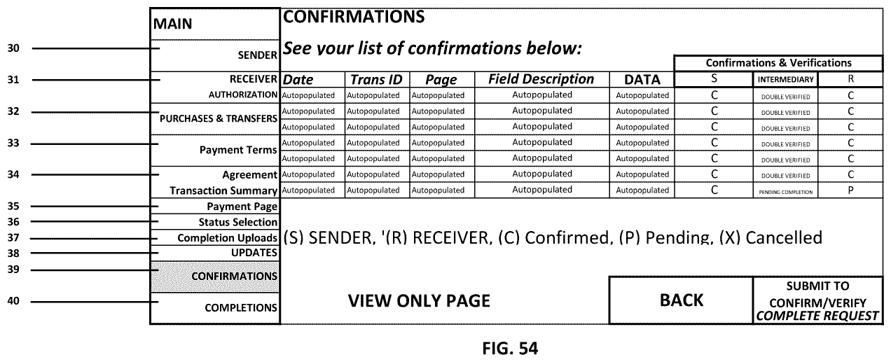

When in the receiver authorization mode 31, if the receiver selects the confirmation icon 39 a confirmations page is displayed to the receiver as shown in FIG. 54. The receiver views transaction conditions confirmations, updates, cancellations, and pending transaction records. Once completed, the receiver selects “submit to confirm/verify” to confirm the information to be verified by the intermediary.

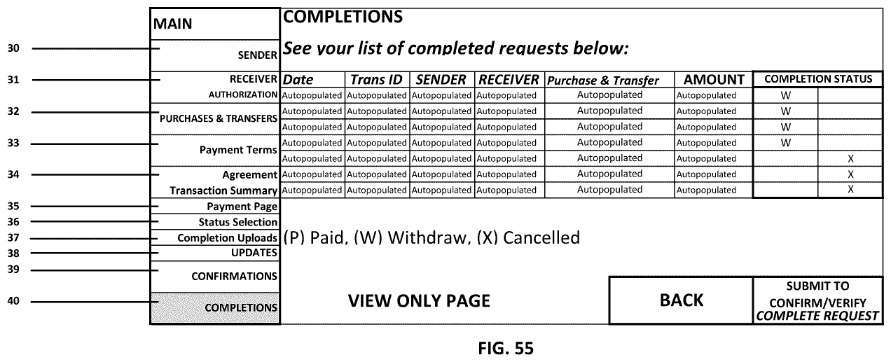

When in the receiver authorization mode 31, if the receiver selects the completions icon 40 a completions page is displayed to the receiver as shown in FIG. 55. The receiver views the completed transactions, transaction records, and status. Once completed, the receiver selects “submit to confirm/verify” to confirm the information to be verified by the intermediary.

The method of this disclosure provides real-time agreement transaction condition negotiations via an intermediary controlled process that implements disbursement payment holds before the completion of the agreement transaction conditions and before payment to the receiver. The method includes permission from both the sender and the receiver to allow the intermediary to act on behalf of the seller and receiver. Further, the method provides ID multi-verification, code creation, multi-confirmations, multi agreement transaction verifications, responses, cancellations, and mediation protections which further guarantee completion of the agreement transaction conditions and eliminate risks prior to payment release.

The sender and receiver authorize the intermediary to use the intermediary's own systems and methods to control and enforce the agreement transaction conditions without prejudice towards the sender or the receiver. The sender is required by intermediary to make payment. The sender, preferably, is required to request withdrawal of funds, from the payment of funds by the sender to the intermediary, when applicable. The sender, preferably, is required to agree to request withdrawal of funds after confirmations and response and/or cancellation protections are put into effect during a specified period of time. The receiver is required by the intermediary to provide goods/services. The receiver, preferably, is required to request withdrawal of funds and must agree to request withdrawal of funds after confirmations and response and/or cancellation protections are put into effect during a specified period of time.

Agreement transaction conditions can be initiated, created, modified, confirmed, and cancelled by either the sender or the receiver. The sender and the receiver both have response protection because the sender (purchaser) has access to funds after payment and the receiver (provider) has access to the non-refundable payment of funds made by the sender to the intermediary. The non-refundable payment of funds provides access to the funds, or to a partial amount of the funds, for the receiver. There is cancellation protection for both the sender and the receiver. The sender has access to the funds after payment for purchases from the receiver. The receiver has access to the funds, or partial funds, after payment of funds by the sender to the intermediary.

The foregoing description illustrates and describes the system and method of the disclosure. Additionally, the disclosure shows and describes only the preferred embodiments but as mentioned above, it is to be understood that the preferred embodiments are capable of being formed in various other combinations, modifications, and environments and are capable of changes or modifications within the scope of the invention concepts as expressed herein, commensurate with the above teachings and/or the skill or knowledge of the relevant art. The embodiments described herein above are further intended to explain the best modes known by applicant and to enable others skilled in the art to utilize the disclosure in such, or other, embodiments and with the various modifications required by the particular application or uses thereof. Accordingly, the description is not intended to limit the invention to the form disclosed herein. Also, it is intended that the appended claims be construed to include alternative embodiments. It will be further understood that various changes in the details, materials, and arrangements of the parts which have been described and illustrated above to explain the nature of this invention may be made by those skilled in the art without departing from the principle and scope of the invention as recited in the following claims.

1. A computer implemented intermediary transaction method, comprising
1) connecting to a computer system of an intermediary, over a network, by a sender using the sender's computer system, wherein the intermediary communicates with and mediates negotiations between senders and receivers in transactions over the network;
2) making payment by the sender to the intermediary over the network for the purchase of goods and/or services from a receiver;
3) entering by the sender over the network into electronic entry forms provided by the intermediary's computer, transaction conditions between the sender and the receiver for the purchase of goods and/or services and the confirmation by the sender of the transaction conditions, and submitting over the network the confirmed transaction conditions to the intermediary;
4) notifying the receiver by the intermediary over the network, through the receiver's computer system, the sender's confirmation of the transaction conditions, and payment for goods and/or services;
5) receiving over the network by the receiver from the intermediary transaction conditions confirmed by the sender and a) entering by the receiver into electronic entry forms provided by the intermediary's computer system the receiver's confirmation of the transaction conditions confirmed by the sender or b) updating by the receiver the transaction conditions confirmed by the sender and entering by the receiver into the electronic entry forms the receiver's confirmation of the receiver's updated transaction conditions, and submitting the confirmed transaction conditions of the sender, or the confirmed updated transaction conditions of the receiver, to the intermediary;
6) notifying the sender by the intermediary of the confirmation by the receiver of the transaction conditions confirmed by the sender, or of the confirmation by the receiver of the updates to the transaction conditions by the receiver;
7) receiving by the sender the goods and/or services from the receiver if there were no updates to the transaction conditions by the receiver or if the sender confirmed the updates of the transaction conditions confirmed by the receiver;
8) notifying the intermediary by the sender that sender received the goods and/or services from the receiver; and
9) transferring by the intermediary to the receiver the sender's payment for the goods and/or services.

2. The method of claim 1, further comprising a) confirming and verifying by the intermediary the transaction conditions confirmed by the sender and b) confirming and verifying by the intermediary the receiver's confirmation of the transaction conditions confirmed by the sender or confirming and verifying by the intermediary the receiver's and sender's confirmation of the receiver's updated transaction conditions, wherein the sender and the receiver authorize the intermediary to enforce the transaction conditions.

3. The method of claim 1, further comprising holding the sender's payment in escrow by the intermediary until transaction conditions are met by the receiver.

4. The method of claim 1, further comprising making payment by the sender and receiver, over the network, to the intermediary for services provided to the sender and receiver by the intermediary.

5. The method of claim 1, further comprising requesting by the intermediary, over the network, the receiver to enter proof of completion of performance of the transaction conditions and entering, over the network, by the receiver into the electronic entry forms confirmation of completion of the performance of transaction conditions once the proof of completion of the performance of transaction conditions is entered by the receiver over the network.

6. The method of claim 1, further comprising verifying by the intermediary the proof of completion of the performance of the transaction conditions entered by the receiver and notifying by the intermediary, over the network, the sender of the proof of completion of the performance of transaction conditions entered by the receiver.

7. The method of claim 1, further comprising entering by the sender into the electronic entry forms confirmation of the proof of completion of the performance of transaction conditions by the receiver and verifying by the intermediary the sender's confirmation of the proof of completion of the performance transaction conditions entered by the receiver.

8. The method of claim 1, further comprising notifying the receiver by the intermediary that payment for withdrawal is available to the receiver, requesting from the intermediary by the receiver payment for withdrawal, sending by the intermediary over the network payment to the receiver, and notifying the sender and the receiver, over the network, by the intermediary of the proof of completion of the performance of the transaction conditions by both sender and receiver.

9. The method of claim 1, further comprising 1) notifying the receiver, over the network by the sender through the intermediary, of no delivery of goods and/or services by the receiver to the sender, 2) receiving no response by the sender from the receiver after the notifying the receiver, within a period of time specified in the transaction conditions, 3) requesting by the sender, over the network, from the intermediary return of payment to the sender by the intermediary, and 4) sending, over the network, by the intermediary the payment of the sender to the sender.

10. The method of claim 1, further comprising 1) notifying the sender, over the network by the receiver through the intermediary, of delivery of goods and/or services by the receiver to the sender, 2) receiving no response by the receiver from the sender through the intermediary after the notifying the sender through the intermediary, within a period of time specified in the transaction conditions, 3) requesting by the receiver, over the network, from the intermediary payment to the receiver by the intermediary for the delivery of the goods and services, and 4) sending, over the network, by the intermediary the payment to the receiver.

11. The method of claim 1, further comprising 1) delivering the goods and/or services by the receiver to the sender within a period of time specified in the transaction conditions, 2) giving no notice to the sender through the intermediary by the receiver, within a period of time after the delivery of goods and services specified in transaction conditions, of delivery of goods and/or services by the receiver to the sender, 3) receiving no notification from the sender by the intermediary, within a period of time after the delivery of goods and services specified in transaction conditions, that goods and/or services from the receiver are received by the sender, 4) requesting by the receiver, over the network, from the intermediary payment to the receiver by the intermediary for the delivery of the goods and services, and 5) sending, over the network, by the intermediary the payment to the receiver.

12. Computer storage media having computer executable instructions stored thereon which, when executed by one or more processors, cause the processors to execute a computer implemented method for controlling online intermediary transactions, the method comprising:
1) connecting to a computer system of an intermediary, over a network, by a sender using the sender's computer system, wherein the intermediary communicates with and mediates negotiations between senders and receivers in transactions over the network;
2) making payment by the sender to the intermediary over the network for the purchase of goods and/or services from a receiver;
3) entering by the sender over the network into electronic entry forms provided by the intermediary's computer, transaction conditions between the sender and the receiver for the purchase of goods and/or services and the confirmation by the sender of the transaction conditions, and submitting over the network the confirmed transaction conditions to the intermediary;
4) notifying the receiver by the intermediary over the network, through the receiver's computer system, the sender's confirmed agreement transaction conditions, and payment for goods and/or services;
5) receiving over the network by the receiver from the intermediary transaction conditions confirmed by the sender and a) entering by the receiver into electronic entry forms provided by the intermediary's computer system the receiver's confirmation of the transaction conditions confirmed by the sender or b) updating by the receiver the transaction conditions confirmed by the sender and entering by the receiver into the electronic entry forms the receiver's confirmation of the receiver's updated transaction conditions, and submitting the confirmed transaction conditions of the sender, or the confirmed updated transaction conditions of the receiver, to the intermediary;
6) notifying the sender by the intermediary of the confirmation by the receiver of the transaction conditions confirmed by the sender, or of the confirmation by the receiver of the updates to the transaction conditions by the receiver;
7) receiving by the sender the goods and/or services from the receiver if there were no updates to the transaction conditions by the receiver or if the sender confirmed the updates of the transaction conditions confirmed by the receiver;
8) notifying the intermediary by the sender that sender received the goods and/or services from the receiver; and
9) transferring by the intermediary to the receiver the sender's payment for the goods and/or services.

13. The computer storage media of claim 12, further comprising a) confirming and verifying by the intermediary the transaction conditions confirmed by the sender and b) confirming and verifying by the intermediary the receiver's confirmation of the transaction conditions confirmed by the sender or confirming and verifying by the intermediary the receiver's and sender's confirmation of the receiver's updated transaction conditions, wherein the sender and the receiver authorize the intermediary to enforce the transaction conditions.

14. The computer storage media of claim 12, further comprising holding the sender's payment in escrow by the intermediary until transaction conditions are met by the receiver and making payment by the sender and receiver, over the network, to the intermediary for services provided to the sender and receiver by the intermediary.

15. The computer storage media of claim 12, further comprising requesting by the intermediary, over the network, the receiver to enter proof of completion of performance of the transaction conditions and entering, over the network, by the receiver into the electronic entry forms confirmation of completion of the performance of transaction conditions once the proof of completion of the performance of transaction conditions is entered by the receiver over the network.

16. The computer storage media of claim 12, further comprising verifying by the intermediary the proof of completion of the performance of the transaction conditions entered by the receiver and notifying by the intermediary, over the network, the sender of the proof of completion of the performance of transaction conditions entered by the receiver.

17. The computer storage media of claim 12, further comprising entering by the sender into the electronic entry forms confirmation of the proof of completion of the performance of transaction conditions by the receiver and verifying by the intermediary the sender's confirmation of the proof of completion of the performance transaction conditions entered by the receiver, and notifying the receiver by the intermediary that payment for withdrawal is available to the receiver, requesting from the intermediary by the receiver payment for withdrawal, sending by the intermediary over the network payment to the receiver, and notifying the sender and the receiver, over the network, by the intermediary of the proof of completion of the performance of the transaction conditions by both sender and receiver.

18. The computer storage media of claim 12, further comprising 1) notifying the receiver, over the network by the sender through the intermediary, of no delivery of goods and/or services by the receiver to the sender, 2) receiving no response by the sender from the receiver after the notifying the receiver, within a period of time specified in the transaction conditions, 3) requesting by the sender, over the network, from the intermediary return of payment to the sender by the intermediary, and 4) sending, over the network, by the intermediary the payment of the sender to the sender.

19. The computer storage media of claim 12, further comprising 1) notifying the sender, over the network by the receiver through the intermediary, of delivery of goods and/or services by the receiver to the sender, 2) receiving no response by the receiver from the sender through the intermediary after the notifying the sender through the intermediary, within a period of time specified in the transaction conditions, 3) requesting by the receiver, over the network, from the intermediary payment to the receiver by the intermediary for the delivery of the goods and services, and 4) sending, over the network, by the intermediary the payment to the receiver.

20. The computer storage media of claim 12, further comprising 1) delivering the goods and/or services by the receiver to the sender within a period of time specified in the transaction conditions, 2) giving no notice to the sender through the intermediary by the receiver, within a period of time after the delivery of goods and services specified in transaction conditions, of delivery of goods and/or services by the receiver to the sender, 3) receiving no notification from the sender by the intermediary, within a period of time after the delivery of goods and services specified in transaction conditions, that goods and/or services from the receiver are received by the sender, 4) requesting by the receiver, over the network, from the intermediary payment to the receiver by the intermediary for the delivery of the goods and services, and 5) sending, over the network, by the intermediary the payment to the receiver.
